(19) United States
(12) Patent Application Publication
(10) Pub. No.: US 2026/0179035 A1
(43) Pub. Date: Jun. 25, 2026

(54) AUTONOMOUS VEHICLE FOR INVENTORY TRACKING AND/OR TRANSPORT AND RELATED SYSTEMS AND METHODS

(71) Applicant: Dane Technologies, Inc., Maple Grove, MN (US)

(72) Inventor: Dan Johnson, Medina, MN (US)

(21) Appl. No.: 19/534,979

(22) Filed: Feb. 10, 2026

Related U.S. Application Data
(63) Continuation-in-part of application No. 18/600,879, filed on Mar. 11, 2024, now abandoned.
Application No. 18/600,879 is a continuation-in-part of application No. 16/928,993, filed on Jul. 14, 2020, now abandoned.
(60) Provisional application No. 63/756,513, filed on Feb. 10, 2025.

(51) Int. Cl. G06Q 10/087; B65G 1/04

(52) U.S. Cl. CPC G06Q 10/087; B65G 1/0492

(57) ABSTRACT

An autonomous robot for tracking inventory of items in a target area comprising a base, a transport apparatus, a navigation sensor set configured to provide gather navigation and obstacle avoidance data, a sensor mast coupled to and extending upwardly from the base, the sensor mast comprising a main portion and a pole coupled to the main portion, an adjustable sensor array mounted along the sensor mast and comprising a plurality of adjustable sensors positioned at different heights and angular orientations along the sensor mast, wherein the adjustable sensors are configured to detect items on different vertical levels at multiple heights within the target area, and a processor operably coupled to the navigation sensor set and the adjustable sensor array, the processor being configured to receive sensor data and determine at least one of presence, identity, or location information for items. Alternative embodiments include a system for tracking inventory using such an autonomous robot.

### CROSS-REFERENCE TO RELATED APPLICATION(S)

This application claims the benefit under 35 U.S.C. § 119(e) to U.S. Provisional Application 63/756,513, filed Feb. 10, 2025 and entitled “Autonomous Vehicle with Interchangeable Multipurpose Carts and Related Systems and Methods,” and also claims priority as a continuation-in-part of U.S. application Ser. No. 18/600,879, filed Mar. 11, 2024 and entitled “Autonomous Vehicle with Interchangeable, Multipurpose Carts and Related Systems and Methods,” which claims priority as a continuation-in-part of U.S. application Ser. No. 16/928,993, filed Jul. 14, 2020 and entitled “Autonomous Vehicle with Interchangeable Multipurpose Carts and Related Systems and Methods,” all of which are hereby incorporated herein by reference in their entireties.

### FIELD

The various embodiments herein relate to autonomous vehicles (and, in some cases, attachable carts) for use in large spaces such as warehouses, retail spaces, and any other large space to provide management thereof.

### BACKGROUND

It is frequently useful to track the disposition of inventory at a facility and further monitor the location and/or status of that inventory. For example, it is useful to track the presence and location of stored items in a storage facility or other similar location, including for audit purposes. In addition, the threat of viruses and resulting pandemics has increased the need to disinfect various types of facilities/buildings, including warehouses, retail buildings (such as grocery stores, for example), and the like. Further, another important task in such environments is stocking of inventory.

However, each of these tasks (including inventory tracking, disinfection, and inventory stocking) in large facilities/buildings can be difficult for various reasons.

For example, an audit of items stored or stocking of such items in such a building/facility can be an onerous task. Typically, items in a storage facility (such as, for example, goods in a warehouse or grocery store) are generally entered into an inventory list upon arrival at the facility. In an electronic system, the barcode on each item is scanned via RFID technology as it arrives and the information from the barcode is stored electronically. However, in this standard approach, the exact location of the item within the warehouse/retail space is not recorded. Matching records with the actual location of items can become exceedingly difficult due to the sheer volume of items in the facility. As such, if the item is placed in the wrong location or is moved to an unknown or incorrect location, it can be very difficult to locate or confirm the presence of such item.

In that context, a physical audit of the facility/building requires physically finding and identifying every item in the facility—a long and difficult process that can require hundreds, or even thousands, of manhours. As such, known systems and methods for tracking items and performing audits in a storage facility are costly and inefficient.

Further, both stocking of items (placement of the items in the appropriate place in a facility, such as a retail facility or warehouse, for example) and ongoing disinfection of a facility can be time consuming and require substantial costly manhours. In addition, performance of any of these functions in the face of standard traffic during working hours in an operating facility is very difficult, if not impossible, and concurrent performance of two or more of the functions is even more difficult.

There is a need in the art for improved devices, systems, and methods for area disinfection, stocking items, and/or tracking items in a building/facility.

### BRIEF SUMMARY

Discussed herein are various autonomous vehicles (or “robots”) and related systems that can be used to track inventory of items in a large area such as a warehouse or retail building.

In Example 1, an autonomous robot for tracking inventory of items disposed on pallets and/or shelves within a target area comprises a base, a transport apparatus in the base having at least one drive wheel and a motor operably coupled to the at least one drive wheel, wherein the transport apparatus is configured to propel and orient the robot within the target area, a navigation sensor set configured to provide gather navigation and obstacle avoidance data, a sensor mast coupled to and extending upwardly from the base, the sensor mast comprising a main portion and a pole coupled to the main portion, the pole being vertically adjustable between a retracted position and an extended position, an adjustable sensor array mounted along the sensor mast and comprising a plurality of adjustable sensors positioned at different heights and angular orientations along the sensor mast, wherein the adjustable sensors are configured to detect items on different vertical levels at multiple heights within the target area, a processor operably coupled to the navigation sensor set and the adjustable sensor array, the processor being configured to receive sensor data and determine at least one of presence, identity, or location information for items or pallets, and a charging interface on the base configured to couple the robot to an external power source.

Example 2 relates to the autonomous robot according to Example 1, further comprising a top sensor disposed proximate a distal end of the pole and aimed downward to establish a field of view over a front row of pallets to detect pallets or items located behind the front row.

Example 3 relates to the autonomous robot according to Example 2, wherein the processor is coupled to the top sensor, wherein the processor is configured to receive sensor data from the top sensor and determine at least one of presence, identity, or location information for pallets or items behind the front row.

Example 4 relates to the autonomous robot according to Example 1, wherein the navigation sensor set is disposed within a navigation housing on the base.

Example 5 relates to the autonomous robot according to Example 1, further comprising a base sensor set disposed proximate a lower portion of the base and configured to scan at least a lower region of the target area.

Example 6 relates to the autonomous robot according to Example 1, wherein the charging interface comprises a charging plate with electrical contacts configured to mate with complementary contacts of an external charger.

Example 7 relates to the autonomous robot according to Example 6, further comprising a docking and charging station including a station housing with a station charging plate having contact strips positioned to electrically couple with the electrical contacts of the charging plate when the robot docks with the station.

Example 8 relates to the autonomous robot according to Example 7, wherein the docking and charging station includes a visual locating feature detectable by the navigation sensor set to guide docking of the robot.

Example 9 relates to the autonomous robot according to Example 1, wherein the base comprises a battery port having at least two receptacles configured to receive removable battery packs.

Example 10 relates to the autonomous robot according to Example 1, wherein the base includes ballast configured to increase stability of the robot when the pole is in the extended position.

In Example 11, a mobile inventory tracking system for tracking and updating inventory of items within a target area comprises an autonomous robot comprising, a base, a transport apparatus in the base, the transport apparatus comprising at least one drive wheel and a motor operably coupled to the at least one drive wheel to propel and orient the robot within the target area, a navigation sensor set configured to gather navigation and obstacle avoidance data, a sensor mast coupled to and extending upwardly from the base and comprising a main portion and a pole coupled to the main portion, the pole being vertically adjustable between a retracted position and an extended position, an adjustable sensor array mounted along the sensor mast and comprising a plurality of adjustable sensors positioned at different heights and angular orientations along the sensor mast and configured to detect items on different vertical levels at multiple heights within the target area, a charging interface on the base configured to couple the robot to an external power source, and a robot processor operably coupled to the navigation sensor set and the adjustable sensor array and configured to receive sensor data and determine at least one of presence, identity, or location information for items. In addition, the system also comprises a server system having a processor and memory storing an inventory database and executable instructions, the server system being communicatively coupled with the robot via a network interface, wherein the processor of the robot is further configured to associate the determined presence, identity, or location information with robot pose and location data, transmit inventory updates to the server system for storage in the inventory database, and receive navigation or task instructions from the server system. In addition, the executable instructions of the server system are configured to cause the server system to receive the inventory updates from the robot, update records in the inventory database with item identity and location information, and transmit route planning or coverage pattern instructions to the robot such that the robot autonomously traverses the target area to detect items at multiple heights. Further, the system also comprises a docking and charging station disposed within the target area and configured to couple with the charging interface of the robot, the robot processor being configured to initiate a docking routine to the robot based on at least one operating condition including a state of charge or completion of a tracking routine.

Example 12 relates to the mobile inventory tracking system according to Example 11, wherein at least some of the items within the target area are disposed on pallets and/or shelves.

Example 13 relates to the mobile inventory tracking system according to Example 11, further comprising a top sensor disposed proximate a distal end of the pole and aimed downward to obtain a line of sight over a front row of pallets to detect pallets or items located behind the front row.

Example 14 relates to the mobile inventory tracking system according to Example 13, wherein the robot processor is configured to receive sensor data from the top sensor and determine at least one of presence, identity, or location information for pallets or items behind the front row.

Example 15 relates to the mobile inventory tracking system according to Example 11, wherein the robot processor is configured to generate a three-dimensional representation of pallet contents from sensor data, compute a present volume of the pallet contents, compare the present volume to a predetermined full volume associated with a stock keeping unit, and determine a count of remaining cases based on a difference between the present volume and the predetermined full volume.

Example 16 relates to the mobile inventory tracking system according to Example 11, wherein the docking and charging station includes a visual locating feature detectable by the navigation sensor set to guide docking of the robot and electrical coupling between a charging plate on the robot and contact strips on the station.

In Example 17, a method of tracking and updating inventory of items within a target area comprises operating an autonomous robot to move and orient within the target area using a transport apparatus, acquiring navigation and obstacle avoidance data with a navigation sensor set of the robot, receiving, at the robot, route planning or coverage pattern instructions from the server system, autonomously traversing the target area according to the route planning or coverage pattern instructions to detect items, detecting items at multiple heights with an adjustable sensor array mounted along a sensor mast, the adjustable sensor array comprising a plurality of adjustable sensors positioned at different heights and angular orientations, detecting at least one of presence, identity, or location information for items based on sensor data received from the adjustable sensor array, associating detected information with robot location data, transmitting inventory updates from the robot to a server system via a network interface, and updating records in an inventory database at the server system with item identity and location information.

Example 18 relates to the method according to Example 17, further comprising initiating a docking routine to dock the robot at a docking and charging station based on at least one operating condition including a state of charge or completion of a tracking routine.

Example 19 relates to the method according to Example 17, further comprising aiming a top sensor disposed proximate a distal end of the pole downward to obtain a line of sight over a front row of pallets and detecting pallets or items located behind the front row based on data from the top sensor.

Example 20 relates to the method according to Example 17, further comprising generating, from sensor data, a three-dimensional representation of pallet contents, computing a present volume of the pallet contents, comparing the present volume to a predetermined full volume associated with a stock keeping unit, and determining a count of remaining cases based on a difference between the present volume and the predetermined full volume.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1A is a perspective view of a multifunctional autonomous vehicle, according to one embodiment.

FIG. 1B is a side view of the autonomous vehicle of FIG. 1A, according to one embodiment.

FIG. 1C is another side view of the autonomous vehicle of FIG. 1A, according to one embodiment.

FIG. 2 is a schematic view of a network for operation of a multifunctional autonomous vehicle in a large area such as a warehouse, according to one embodiment.

FIG. 3A is a perspective view of a multifunctional autonomous vehicle, according to another embodiment.

FIG. 3B is a side view of the autonomous vehicle of FIG. 3A, according to one embodiment.

FIG. 3C is another side view of the autonomous vehicle of FIG. 3A, according to one embodiment.

FIG. 4 is a perspective view of an autonomous vehicle in operation in a warehouse environment, according to one embodiment.

FIG. 5 is a schematic view of a network for operation of an autonomous vehicle with a multifunctional cart in a large area such as a warehouse, according to one embodiment.

FIG. 6A is a side view of a multifunctional autonomous vehicle, according to one embodiment.

FIG. 6B is a front view of the autonomous vehicle of FIG. 6A, according to one embodiment.

FIG. 6C is a top view of the autonomous vehicle of FIG. 6A, according to one embodiment.

FIG. 7A is a perspective view of a multifunctional cart, according to one embodiment.

FIG. 7B is a side view of the multifunctional cart of FIG. 7A, according to one embodiment.

FIG. 7C is a front view of the multifunctional cart of FIG. 7A, according to one embodiment.

FIG. 7D is a rear view of the multifunctional cart of FIG. 7A, according to one embodiment.

FIG. 8A is a side view of a multifunctional cart with a removable scaffold, according to another embodiment.

FIG. 8B is a rear view of the multifunctional cart of FIG. 8A, according to one embodiment.

FIG. 9A is a perspective view of a multifunctional cart with two removable scaffolds, according to a further embodiment.

FIG. 9B is a side view of the multifunctional cart of FIG. 9A, according to one embodiment.

FIG. 9C is a top view of the multifunctional cart of FIG. 9A, according to one embodiment.

FIG. 10A is a perspective view of a multifunctional autonomous vehicle and cart, according to one embodiment.

FIG. 10B is a perspective view of a multifunctional autonomous vehicle and cart, according to one embodiment.

FIG. 11 is a rear view of an autonomous vehicle base and cart, according to one embodiment.

FIG. 12 is a top perspective view of an autonomous vehicle base cover, according to one embodiment.

FIG. 13A is a perspective view of a coupling mechanism of an autonomous vehicle base, according to one embodiment.

FIG. 13B is a perspective view of a coupling mechanism, according to one embodiment.

FIG. 14 is a top view of a multifunctional area in which an autonomous vehicle can be used, according to one embodiment.

FIG. 15 is a flowchart of a method of use of a system including an autonomous vehicle in a multifunctional area, according to one embodiment.

FIG. 16A is a front view of an autonomous inventory robot according to one embodiment.

FIG. 16B is a right side view of an autonomous inventory robot according to one embodiment.

FIG. 16C is a underside exploded view of a positioner of an autonomous inventory robot according to one embodiment.

FIG. 17A is a front view of an autonomous inventory robot and respective fields of view of certain sensors according to one embodiment.

FIG. 17B is an isometric view of an autonomous inventory robot and respective fields of view of certain sensors according to one embodiment.

FIG. 18A is a front view of an autonomous inventory robot and respective fields of view of certain sensors according to one embodiment.

FIG. 18B is an isometric view of an autonomous inventory robot and respective fields of view of certain sensors according to one embodiment.

FIG. 19A is a perspective view of an autonomous vehicle in operation in a warehouse, retail, or other environment with shelving, according to one embodiment.

FIG. 19B is a perspective view of another autonomous vehicle in operation in a warehouse, retail, or other environment with shelving, according to one embodiment.

FIG. 19C is a perspective view of yet another autonomous vehicle in operation in a warehouse, retail, or other environment with shelving, according to one embodiment.

FIG. 20A is a side view of an autonomous inventory robot, according to one embodiment.

FIG. 20B is a back view of the autonomous inventory robot of FIG. 20A, according to one embodiment.

FIG. 21A is an expanded perspective view of a portion of the back of the autonomous inventory robot of FIG. 20A, according to one embodiment.

FIG. 21B is an expanded, exploded perspective view of the portion of the autonomous inventory robot of FIG. 21A, according to one embodiment.

FIG. 22 is a perspective view of the underside of the base of the autonomous inventory robot of FIG. 20A, according to one embodiment.

FIG. 23 is an expanded perspective view of the base and lidar sensor of the autonomous inventory robot of FIG. 20A, according to one embodiment.

FIG. 24A is a perspective view of a portion of the autonomous inventory robot of FIG. 20A with a docking/charging station, according to one embodiment.

FIG. 24B is a side view of the portion of the autonomous inventory robot and docking/charging station of FIG. 24A, according to one embodiment.

FIG. 24C is a perspective view of the autonomous inventory robot and docking/charging station of FIG. 24A in which the robot has moved in close proximity with the station, according to one embodiment.

FIG. 24D is a side view of the robot and docking/charging station of FIG. 24A in which the robot is docked with the docking/charging station, according to one embodiment.

FIG. 25A is an expanded perspective view of the base and battery port of the autonomous robot of FIG. 20A, according to one embodiment.

FIG. 25B is another expanded perspective view of the base and battery port of FIG. 25A, according to one embodiment.

FIG. 26A is a perspective view of an autonomous inventory robot, according to one embodiment.

FIG. 26B is a side view of the autonomous inventory robot of FIG. 26A, according to one embodiment.

FIG. 26C is a back view of the autonomous inventory robot of FIG. 26A, according to one embodiment.

FIG. 26D is a back view of the autonomous inventory robot of FIG. 26A in the collapsed or folded configuration, according to one embodiment.

FIG. 26E is a side view of the autonomous inventory robot of FIG. 26A in the collapsed or folded configuration, according to one embodiment.

FIG. 26F is a front view of the autonomous inventory robot of FIG. 26A in the collapsed or folded configuration, according to one embodiment.

FIG. 26G is a perspective view of the autonomous inventory robot of FIG. 26A in the collapsed or folded configuration, according to one embodiment.

### DETAILED DESCRIPTION

The various embodiments herein relate to a system that includes an autonomous vehicle for use in a retail, warehouse, or other indoor or outdoor space for tracking and/or transporting items within the target area. In some alternatives, the system includes one or more autonomous vehicles and one or more attachable carts that can perform additional tasks while being hauled or otherwise transported around the target area by the autonomous vehicle. One of the vehicles and/or the carts can be an inventory tracking vehicle or cart, while another can be a disinfection vehicle or cart, and another can be an inventory stocking vehicle or cart. Further, the various embodiments herein can also include methods and systems for utilizing the autonomous vehicle and/or the attachable carts for disinfection of the target space, along with the comprehensive stocking, tracking, and/or auditing of items in a facility and/or, such as, for example, goods at a warehouse or in a grocery store or other retail space. In certain embodiments, the autonomous vehicle has the tracking, transporting, and/or disinfection features built into the vehicle such that the attachable carts are unnecessary. In another alternative, one attachable cart can incorporate at least two of the stocking, tracking, and/or disinfection components/features thereon.

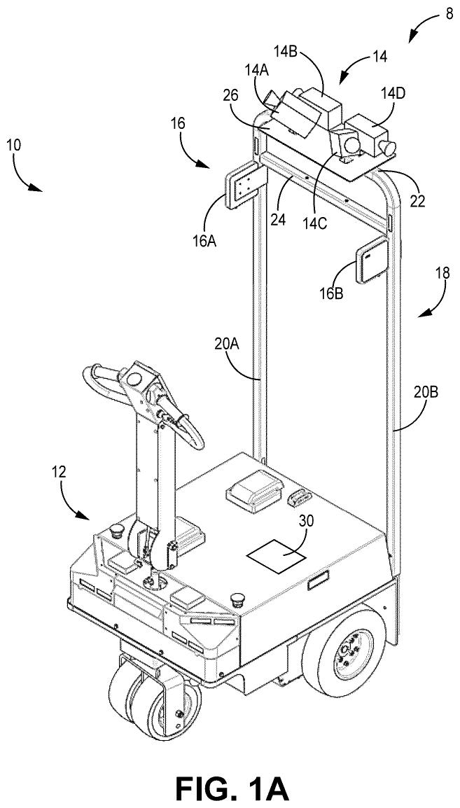

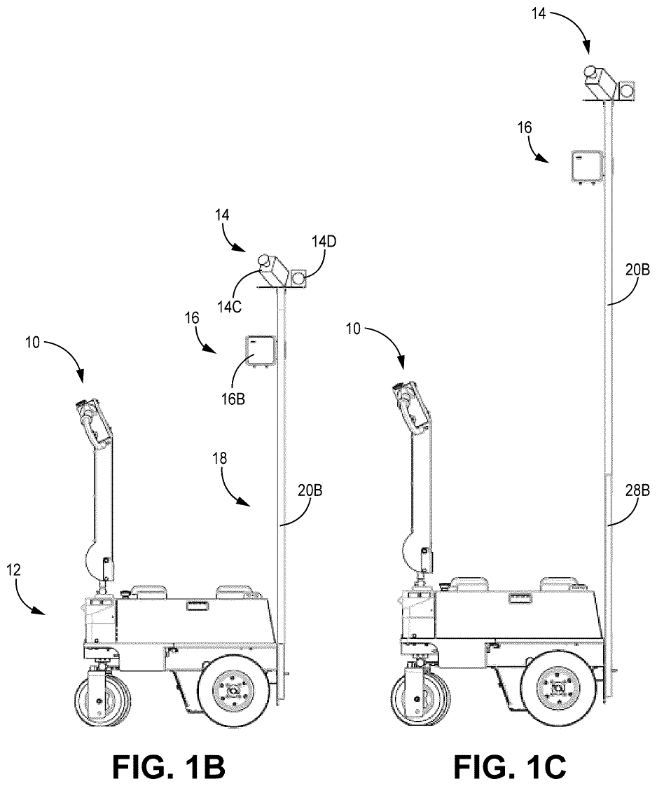

According to one embodiment as depicted in FIGS. 1A-1C, the vehicle 10 is a tracking vehicle 10 that is an autonomous transportation apparatus 12 having a collection apparatus 8 disposed thereon. In this implementation, the collection apparatus 8 has at least one sensor 14, 16 attached to an extendable mast 18. In one example, the sensors 14,16 are a digital camera 14 and at least one RFID reader 16 both attached to the extendable mast 18. The extendable mast 18 has two extendable rods 20A, 20B that are connected at a top portion via the upper crossbar 22 and lower crossbar 24. More specifically, the collection apparatus 8 has four digital cameras 14A, 14B, 14C, 14D and two RFID readers 16A, 16B attached to the mast 18. The cameras 14A-14C are disposed on a camera platform 26, which in turn is disposed on the upper crossbar 22. The RFID readers 16A, 16B are attached to the first and second rods 20A, 20B, respectively. Alternatively, the collection apparatus 8 (and any other autonomous vehicle disclosed or contemplated herein) can include any sensor as described or contemplated herein, including not only any camera (such as any 3D or stereo camera, depth-sensing camera, thermal imaging device, or the like) or RFID reader, but also any known LIDAR, Bluetooth low energy (“BLE”), or any other known sensor or reader for collecting information from the surrounding area, including inventory information or the like.

It is understood that the mast 18 is not limited to the specific two rod and two crossbar configuration in this specific example. Instead, the mast 18 can have any known configuration, including a single extendable rod or any type of extendable mechanism or component. Further, it is understood that the number of cameras 14 and the number of RFID readers 16 can be any number that is useful for capturing the target information, and that those cameras 14 and RFID readers 16 can be attached or otherwise coupled to the mast 18 in any known fashion or using any known mechanism.

FIGS. 1B and 1C depict the two main positions of the extendable mast 18: the unextended or base position in FIG. 1B and its extended or deployed position in FIG. 1C. In this specific embodiment, the first and second rods 20A, 20B are extendable outer rods 20A, 20B that are disposed over and extendable in relation to the first and second base or inner rods 28A, 28B (only inner rod 28B is depicted in FIG. 1C, because inner rod 28A is disposed directly behind inner rod 28B when viewing the vehicle 10 from the side as shown). As such, as the first and second outer rods 20A, 20B move toward their extended position in which the mast 18 is raised as shown in FIG. 1C, the inner rods 28A, 28B, which remain stationary and attached to the vehicle 12, become visible.

Each of the one or more cameras 14 in any of the vehicle embodiments herein can be any known digital camera that can capture a barcode or other information printed on an item. In the implementation as shown in FIG. 1A (and, the at least one camera 14 can include at least one camera (such as 14B) aimed out to one side of the vehicle 10 (in a direction parallel to the crossbar 22) and at least one camera (such as 14D) aimed toward the other, opposite side of the vehicle 10 (again, parallel to the crossbar 22). Alternatively, as shown in the specific exemplary embodiment of FIG. 1A, the at least one camera 14 can be four cameras 14A-14D, with two cameras 14A, 14B aimed generally toward one side of the vehicle and two cameras 14C, 14D aimed toward the other. In a further implementation, any vehicle embodiment disclosed or contemplated herein can have any number of cameras (one, two, three, four, five, six, seven, eight, or more) to operate as described herein.

The presence of at least two cameras (such as cameras 14B and 14D) aimed toward the sides of the vehicle 10 as shown allows for capturing information photographically on both sides of the vehicle 10. For example, in a warehouse environment in which the vehicle is positioned to advance down an aisle with two rows of shelving (one on each side of the aisle), two such cameras can capture images of any information provided on each item positioned on those shelves (or the absence of items), as will be described in further detail below. In certain embodiments (including, for example, the vehicle 10 of FIG. 1A), while two cameras 14B, 14D are disposed substantially parallel to the crossbar 22, two other cameras 14A, 14C are disposed at an angle such that the view each camera 14A, 14C captures is an area that is higher vertically in relation to the views captured by the parallel cameras 14B, 14D, thereby allowing the angled cameras 14A, 14C to capture images of items disposed at a greater height than the items captured by the parallel cameras 14A, 14C. And the extendable mast 18 allows for the cameras 14 to be raised to capture images of items disposed at a height that is higher than items disposed at or near the floor on which the device 10 is disposed, such as on shelves that are positioned above the ground- or floor-level shelves, as will also be described in further detail below.

As will also be described in further detail below, the vehicle 10 depicted in FIG. 1A (and any vehicle embodiment disclosed or contemplated herein) can also, in certain embodiments, have an on-board processor 30 coupled to the cameras 14. Further, the processor 30 can have software that processes the electronic images captured by the cameras 14 and enlarge or otherwise process the images to identify the information captured on the target items by the cameras. For example, in one embodiment, the software identifies any barcodes on any item captured by one of the cameras and captures the information in such barcodes, including identification of the item to which the barcode is attached and any other information provided therein. This process will be described in further detail below.

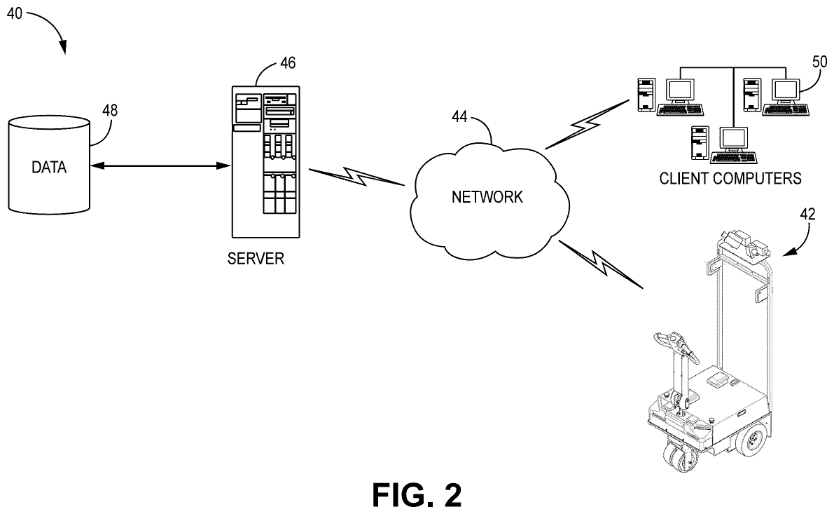

FIG. 2 depicts a schematic diagram of one embodiment of a network-based system 40 for tracking multiple items at a facility (or the absence thereof) and/or performing an audit of such items. As shown, the system 40 according to one embodiment can include a server 46 in communication with a tracking vehicle 42 according to any implementation herein and client computers 50 through a network 44. The at least one client computers 50 can be separately located at the facility site and/or at other locations, such as third party sites. “Client computers” as used herein shall mean any known type of processor or computer, and can also be referred to as site processors 50 or site computers 50. The system 40 allows for tracking and/or managing items at a facility, such as goods at a warehouse or any other known items at any type of facility that can benefit from tracking and/or an audit of such items. It is understood that the network 44 can be a wireless communication network 44 such as, for example, a Wi-Fi™ network 44, such that the tracking vehicle 42 (and any on-board processor on the vehicle 42 similar to the on-board processor 30 described above) is in communication with the server 46 via the wireless network 44. It is further understood that any of the components (such as the server 46, the vehicle 42, and the computers 50) can be coupled to any one or more of the other components via any other type of network 44, such as the Internet 44, and further than any connection can include multiple networks, such as both Wi-Fi™ and the Internet. In addition, it is understood that any component or feature of the system 40 can be operated via cloud computing and/or cloud storage.

As further shown in FIG. 2, according to one implementation, the server 46 is in communication with at least one database 48. It is understood that either or both the server 46 or the database 48 can be replaced with known cloud computing components. According to one embodiment, the database 48 contains information regarding each item, such as item identification, description, location in the facility, base cost, historical maintenance and service information (where appropriate), or any other kind of information relating to the item. Further, it is understood that the database 48 can also include any other known type of information relating to the item and/or the facility. For example, the information can include bays, shelves, or areas that are empty. That is, it identifies any spaces or areas in the facility that do not contain an item. Alternatively, various embodiments of the system described herein can have separate databases for various different kinds of information, including the information discussed herein.

It is understood that the server or central processor 46 (also referred to herein as an “system processor”) can be any computer or cloud-based server known to those skilled in the art. In one embodiment, the central processor 46 includes a website hosted in at least one or more computer servers. It is understood that any system disclosed herein may have one or more such server 46 and that each server may comprise a web server, a database server and/or application server, any of which may run on a variety of platforms. The server 46 can have any known configuration and have any known components, including, for example, a monitor or other screen device and an input device, such as a keyboard, a mouse, or a touch sensitive screen. Some non-limiting commercial examples of servers that could be used with various embodiments disclosed herein include Dell 2950, Sun Solaris, HP 9000 series, and IBM x3000 series.

In one implementation, the central processor 46 includes software programs or instructions that run on the server-side to process requests and responses from a client computer 50. These software programs or instructions send information to the client computer 50, perform calculation, compilation, and storage functions, transmit instructions to the client computer 50 or to one or more tracking vehicle 42, and generate reports. It is understood that any embodiment of the systems disclosed herein that provide for data collection, storage, tracking, and managing can be controlled using software associated with the system. It is further understood that the software can be any known software for use with the systems described herein to track and manage the item information as described herein.

In the system 40, generally, item data, including item tracking date, entered into the system 40 via the tracking vehicle 42 and/or a client computer or processor 50 is received by the server 46 and stored in the database 48. The database 48 serves as the inputs to and information storage for the system 40. According to one embodiment, the database 48 may be of any type generally known in the art, may be integral to the central processor 46, or may be accessible to the central processor 46 through a computer network or other suitable communication link. In one embodiment, the database 48 is comprised of a plurality of database servers, some of which are integral to the central processor 46, and some that are located remotely from the central processor 46. Some non-limiting commercial examples of databases that could be used with various embodiments disclosed herein include Oracle 9i, Oracle 10g, Microsoft SQL Server, PostSQL, and Ingress.

The tracking vehicle 42 can be any embodiment of such a vehicle as disclosed or contemplated herein for collection of item information in the context of a facility in which the item is located. As used herein, “item” is intended to include any object of any kind that might be retained or otherwise located at a facility of any kind.

In certain embodiments of the system 40, the tracking vehicle 42 can have an on-board processor and software similar to the processor 30 and software described above. Alternatively, the information capturing and processing software as described elsewhere herein can be disposed on the server 46. In a further alternative, the software can be disposed on both the on-board processor (such as processor 30) and on the server 46.

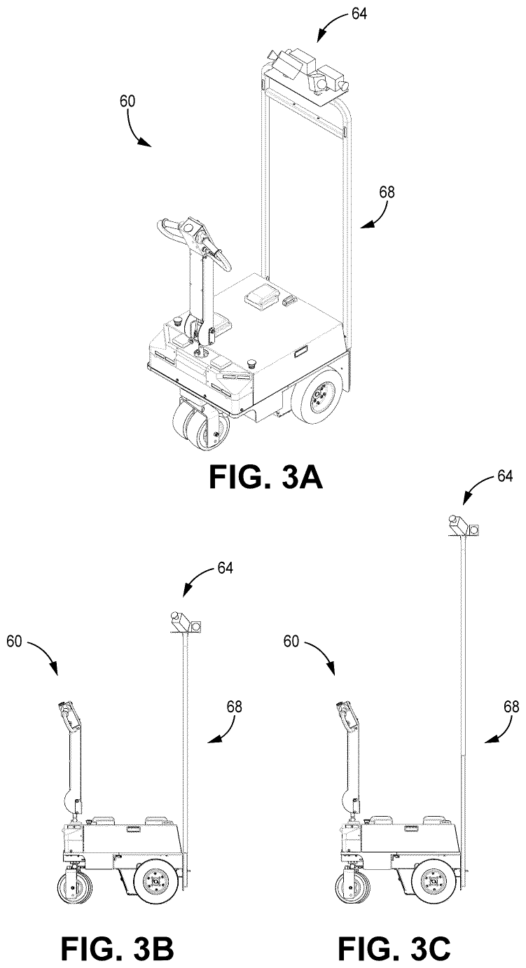

FIGS. 3A-3C depicts another embodiment of a tracking vehicle 60. In this implementation, the tracking vehicle 60 is substantially similar to the vehicle 10 discussed above. That is, it is understood that each feature or component of the vehicle 60 is substantially the same or identical to the corresponding feature or component with respect to the vehicle 10, except as discussed herein. In this implementation, the collection apparatus 62 has at least one digital camera 64 attached to an extendable mast 68, but no RFID reader.

Returning to FIG. 1A (and corresponding FIG. 3A), according to one embodiment, the base vehicle 12 is an autonomous transportation apparatus 12 that can be operated autonomously or manually. According to one specific example, the base vehicle 12 is an apparatus that can transport carts or other types of trailers as disclosed in U.S. Pat. No. 9,010,771, which is hereby incorporated herein by reference in its entirety. In an alternative specific example, the vehicle 12 is an autonomous version of the apparatus of the '771 Patent. In a further alternative, the base vehicle 12 can be any known self-propelled or manually-propelled vehicle—and can either be autonomously or manually controlled—that can move about and operate in a facility of interest. Regardless of the vehicle 12, it is understood that the vehicle 12 has a collection apparatus (such as the apparatus 8 discussed above) attached thereto such that the vehicle is an inventory tracking vehicle.

In an alternative embodiment, the tracking apparatus can be a tracking trailer or cart as described elsewhere herein that is hitched or otherwise attached to a vehicle (such as any vehicle 12 disclosed or contemplated herein). The tracking trailer can be any wheeled apparatus to which the collection apparatus (such as apparatus 8 discussed above or any other such apparatus disclosed or contemplated herein) is coupled. As such, the tracking trailer can be attached to the vehicle 12 such that the trailer is pulled around the facility by the vehicle 12, thereby allowing the collection apparatus to collect information in the same fashion as any embodiment herein.

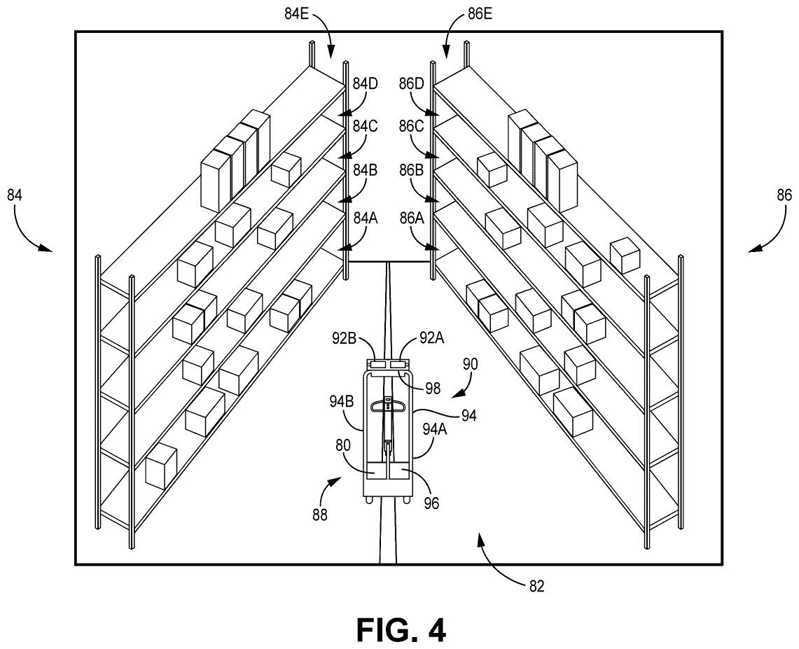

In use, the various system and device embodiments herein can be used to track items (or lack thereof) in a facility in the following fashion. One or more tracking vehicles (such as vehicle 10 or 42, for example) can be operated to travel through the facility and capture images of items and/or empty spaces located therein. For example, FIG. 4, according to one implementation, depicts a tracking vehicle 80 traveling down an aisle 82 in a facility with shelves 84, 86 of items on both sides of the aisle 82. More specifically, in this particular aisle, the shelving 84 on the left has five levels 84A, 84B, 84C, 84D, 84E as shown, including the floor level 84A, a first shelf 84B, a second shelf 84C, a third shelf 84D, and a fourth shelf 84E. Similarly, the shelving 86 on the right has the same five levels 86A, 86B, 86C, 86D, 86E. Alternatively, any type of shelving configuration with any known number of levels is contemplated.

The tracking vehicle 80 has similar or identical components and features as any of the vehicle embodiments herein. For purposes of this specific example, the vehicle 80 is an autonomous transportation apparatus 88 that is configured to push and/or pull carts (which can contain items) and has a collection apparatus 90 disposed thereon. In this implementation, the collection apparatus 90 has two digital cameras 92A, 92B attached to an extendable mast 94. The extendable mast 94 has two extendable rods 94A, 94B that are coupled at a lower portion of the rods 94A, 94B to the vehicle body 96 and connected to each other at a top portion via the crossbar 98.

In this embodiment, each of the two cameras 92A, 92B has a field of view that is large enough to capture two levels of the shelving 84, 86. As such, with the mast 94 in its base (or unextended) position, the first camera 92A can capture in its field of view the items on the floor level 86A and the first shelf 86B, while the second camera 92B can capture the items on the floor level 84A and the first shelf 84B. Once the vehicle 80 has travelled the entire length of the aisle 82 such that the cameras 92A, 92B have captured images of all the items and empty spaces on the floor level 84A, 86A and the first shelf 84B, 86B of each set of shelves 84, 86, the vehicle can travel the entire length of the aisle 82 a second time with the mast 94 extended such that the two cameras 92A, 92B can capture the next two levels of shelving. More specifically, on the second trip down the aisle 82, the mast 94 is extended such that the first camera 92A can capture in its field of view the items and empty spaces on the second shelf 86C and the third shelf 86D, while the second camera 92B can capture the items and empty spaces on the second shelf 84C and the third shelf 84D. And this continues, with the vehicle 80 making additional trips with the mast 94 further extended to the appropriate additional height each time such that the items and empty spaces on the higher shelves can be captured in images as well. And this process can continue for each aisle and/or set of shelves in the facility until all the items and empty spaces in the facility have been imaged. Alternatively, this process can be limited to a specific aisle, set of aisles, or section of the facility for some targeted tracking for any specific purpose.

In certain implementations, each camera 92A, 92B can identify a barcode (or other target summary of information) of an item in its field of view and “zoom in” to enlarge the barcode and capture the best, largest image of the barcode. That is, each camera 92A, 92B is configured to identify a barcode or other information summary of an item, in certain embodiments via software present in each camera 92A, 92B itself. Once the location of the barcode within the field of view is identified, the camera 92A, 92B is caused by the software to zoom in to the barcode itself, thereby increasing the size of the barcode with in the field of view while eliminating as many other things from the field of view as possible prior to capturing an image of the barcode. This same process is repeated for each item barcode identified within the wider field of view of the camera 92A, 92B. It is understood that any camera on any tracking vehicle embodiment disclose or contemplated herein can operate via the same process.

Similarly, according to any embodiment disclosed or contemplated herein, in those spaces (or bays) in which no item is positioned (an “empty space” or “empty bay,” each camera can capture an image of that empty space. Alternatively, each bay or space can have a barcode or other information summary disposed along a back wall or other location in the back of the space such that the “empty barcode” is only captured by the camera when the bay is empty. As such, the camera zooms in on the “empty” barcode via the same process described above, and the “empty barcode” information is collected such that the system can identify and track bays that don't contain any items.

As or after the images are captured, the electronic images are transported from the cameras 92 to the on-board processor (such as processor 30 discussed above) or transmitted via a wireless connection (such as the wireless connection in FIG. 2) and a network (such as the network 44) to a server (such as server 46). At the on-board processor or the server, the software described above is used to process the image and identify information captured about each item. In certain specific embodiments, the images are processed to enlarge and read the barcodes on each item, and then storing the information from the barcode. In certain embodiments, the location of the tracking vehicle 80 (and thus the location of the barcode) is linked or otherwise associated with the image, thereby providing location information regarding that barcode (and thus the item to which the barcode is attached). Other information about the item can also be included on the barcode and thus stored by the processor or server. In one embodiment, the information is stored in a database (such as database 48 in FIG. 2). In a further alternative, the electronic images are stored in the cameras 92 or transmitted to an on-board database (not shown) on the vehicle 80 and stored for later transmission. According to yet another alternative, the software in the on-board processor (such as processor 30) identifies the barcode and transmits solely the barcode data and the location via the wireless connection while storing the full image in the on-board database for subsequent physical transfer and analytics. Once the vehicle 80 returns to its home base, storage bay, or other home location within the facility, a physical connection can be coupled to the vehicle 80 and the electronic images can be transported via the physical connection to the server (such as server 46 of FIG. 2) or other similar location on a system (such as system 40 in FIG. 2) for the information processing described elsewhere herein.

In one implementation, the image collection process described above can be accomplished while the tracking vehicle 80 is pushing/pulling carts (not shown) around the facility. As such, the image collection process can take place while the tracking vehicle 80 is being used to transport items to various areas or retrieve items from various areas, thereby resulting in a dual-functionality for the vehicle 80 in which both functions can be performed at the same time. Alternatively, the tracking vehicle 80 can be programmed or operated to perform solely the image collection process, including, for example, performing the process at any time during the day when the vehicle 80 is not being used to transport carts containing items or at any time at night while the facility is generally empty of people and there is no item transportation taking place.

According to one embodiment, the image collection process can be performed as an ongoing, day-to-day process that confirms or updates the location of each item in the facility (and other information about the item) while the tracking vehicle (such as vehicle 80) performs its cart/item transportation functions within the facility. Alternatively, the vehicle can be used solely for the image collection process and location tracking at any given time during the day or night, as discussed above. In a further alternative, the tracking vehicle can be operated to perform the image collection process as part of an audit of the facility. That is, the image collection that includes location information for each item can be stored and used as visual evidence of the location of the item within the facility, thereby eliminating the need for audit personnel to physically walk through the entire facility and physically identify every single item therein. Instead, the images with location information can be stored and used as evidence of the physical location of the item.

The various embodiments of tracking vehicles and systems disclosed or contemplated herein can also have a real-time alarm functionality that alerts a user about important item information at the time the information is collected. For example, if a user at a facility is attempting to find a specific item, the user can enter the information about that item and/or its barcode into the system, thereby creating an alarm that causes the system to trigger an alert to the user (transmitted to the user's computer, smartphone, or other device) when that barcode (and location thereof) is identified by the system during the image collection process.

As such, according to certain embodiments, the system and vehicle embodiments disclosed or contemplated herein provide accurate tracking of items and empty spaces in a facility. That is, the system, device, and method embodiments provide for tracking the physical location of and any movement of an item, such that all items at a particular location can be monitored such that movement of any existing item from one location to another within the facility or out of that facility or any importation of a new item into the facility can be monitored. Further, the various embodiments can be used to identify empty spaces in the facility, thereby providing useful information about available space for further items or about potentially missing items that were expected to be located in those spaces. According to another embodiment as described in further detail above, the discovery of an item at a new or different location can trigger the system to transmit a message or electronic alert in any form to an appropriate user. The message or alert can prompt the user to confirm that the location of the item is authorized. In a further alternative, the message can provide any appropriate information relating to the item and/or its transport.

The tracking vehicle, according to any embodiment herein, can utilize and provide certain information relating to the barcodes (and thus items to which the barcodes are attached) without utilizing its connection to the central processor of the system. More specifically, the vehicle can provide automatic alarms or notifications that are triggered at the vehicle, not at the central processor or any other part of the system. According to one embodiment, the vehicle 42 in FIG. 2 (or any other vehicle embodiment herein) has an automatic alarm component (not shown). For example, in one embodiment, when an item is identified as being located in an unauthorized or unexpected location as a result of the image of the item (or barcode thereof) being captured and processed, an audio and/or visual alarm associated with the vehicle is triggered by the vehicle. This occurs because (1) the barcode associated with the item includes information that the item is in the wrong location, (2) the barcode was previously identified by a user as a barcode of interest, (3) the “empty barcode” or other indication that a space is empty indicates that an item is missing, or (4) any other reason that it is desirable to trigger an alarm in real-time relating to an item, and the camera captures the information on the barcode, the image is processed and the alarm is automatically triggered by the processor based on that information and the location. Alternatively, any information can be included in the barcode that can trigger an automatic alarm or any other known action at a vehicle for any known purpose.

The systems, methods, and devices disclosed or contemplated herein allow for highly accurate inventory tracking, including, for example, tracking unauthorized movement of items within a facility, the loss of such items, the absence of items from their expected locations, or the availability of empty spaces. In one embodiment, a barcode or other information summary can be associated with an item (that is, the asset can be “tagged”) by a manufacturer or supplier prior to delivering the item to the facility. Alternatively, the barcode or information summary can be added to the item at the facility.

In addition, the various systems, methods, and devices herein can also be used to track, maintain, and/or adjust inventory levels at a facility. Further, the various embodiments can also create an alarm, alert, or communication to be transmitted to a user when the inventory level for a particular item drops below a predetermined level or the number of empty spaces rises above a predetermined level. For example, if a predetermined minimum level of item A in the facility is set at 50 items, and the tracking process as described according to any embodiment herein identifies 49 or fewer of item A, then the alarm is transmitted.

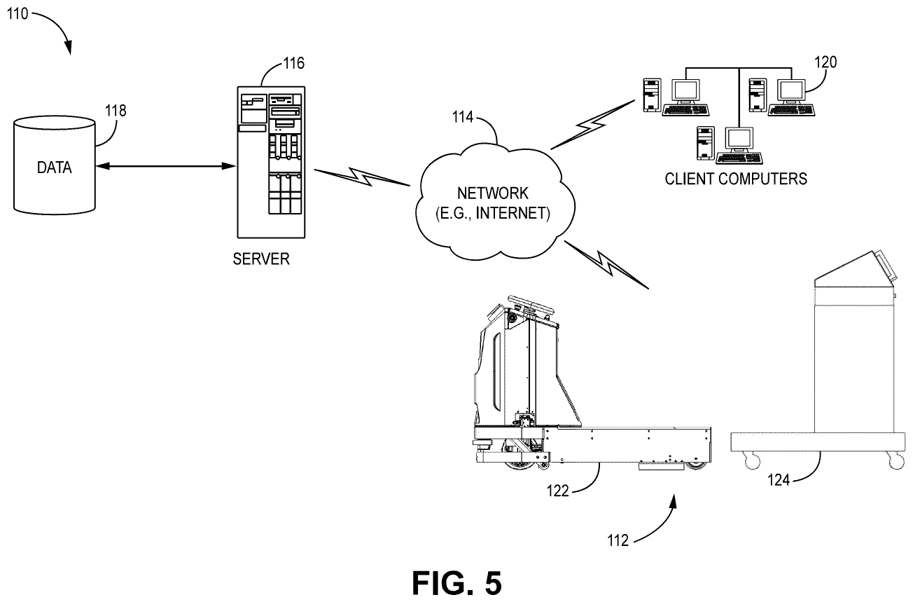

According to other implementations such as that shown in FIG. 5, a system 110 is provided that includes an autonomous, multifunctional system 112 that can be used to perform various different functions in a building setting and collect data relating to those functions. More specifically, as discussed above, the system 110 can be used to stock items in the building, detect and track the presence of items within the building (in a fashion similar to that described above with respect to the tracking vehicle and system embodiments), and/or perform disinfection of target areas of the building using ultraviolet light. In certain embodiments, the autonomous system 112 includes an autonomous self-propelled vehicle 122 and at least one attachable cart 124 as shown, wherein each the cart 124 can be a multi-functional cart 124 or, alternatively, an interchangeable cart 124 that is designed to perform one or more of the various functions.

The various multi-functional system embodiments disclosed or contemplated herein (including the system 112 and the various cart embodiments discussed herein) can be configured to utilize a multi-functional cart that supports the various different functions/activities by having the required sensors or cameras or other equipment for those functions/activities incorporated into or removably added to the cart. Such a multi-functional cart, along with various interchangeable cart embodiments, will be described in further detail below.

The network-based system 110 of FIG. 5 is just one example of a system 110 for operating an autonomous mobile system 112 to stock items, track items, and/or disinfect a specific area of a building/facility. This specific embodiment as shown is substantially similar to the system 40 described above with respect to FIG. 2 except with respect to the differences specified herein. That is, the system 110 also has a server 116 in communication with an autonomous system 112 (including an autonomous powered vehicle 122 and an attachable cart 124) according to any implementation herein and client computers 120 through a network 114. The characteristics and functionality of the similar components (including the client computers 120, the network 114, the server 116, and the database 118) and the operation thereof are substantially the same as the corresponding components as described above with respect to the system 40, except as discussed herein. The system 110 allows for one or more of the following operations: stocking, tracking, and/or managing items at a facility (such as goods at a warehouse, products in a retail establishment, or any other known items at any type of facility that can benefit from stocking, tracking, and/or an audit of such items) and further for disinfecting such a facility. It is understood that the network 114 can be a wireless communication network 114 such that the autonomous mobile system 112 (and any on-board processor(s) on the system 112 as discussed elsewhere herein) is in communication with the server 116 via the wireless network 114.

According to one embodiment, the database 118 can contain information regarding each item to be stocked and/or tracked, such as item identification, description, location in the facility, base cost, historical maintenance and service information (where appropriate), or any other kind of information relating to the item. In addition, the database 118 can contain information regarding the disinfection of the facility, including, for example, the duration of the application of the disinfecting UV light, the intensity of the light, and the time that the disinfection took place. Further, it is understood that the database 118 can also include any other known type of information relating to the item, the disinfection, and/or the facility. Alternatively, various embodiments of the system described herein can have separate databases for various different kinds of information, including the information discussed herein.

It is understood that any embodiment of the systems 110 disclosed herein that provide for the functions described herein can be controlled using software associated with the system. It is further understood that the software in the central processor 116 can be any known software for use with the systems described herein to operate one or more mobile autonomous systems to stock, track, and manage items, disinfect target areas, and process information as described herein.

In the system 110, generally, stocking, item, inventory, and disinfection data, including various types of data as discussed elsewhere herein or as is understood in the art, can be entered into the system 110 via the autonomous mobile system 112 and/or a client computer or processor 120 such that the data is received by the server 116 and stored in the database 118.

The mobile autonomous system 112, according to one implementation, is a combination of an autonomous powered vehicle (also referred to as an “autonomous prime mover”) 122 and at least one attachable, interchangeable cart 124 that can be attached to and can be transported to any desired location within the facility by the powered vehicle 122. Embodiments of the powered vehicle 122 and the interchangeable carts 124 will be described in additional detail below.

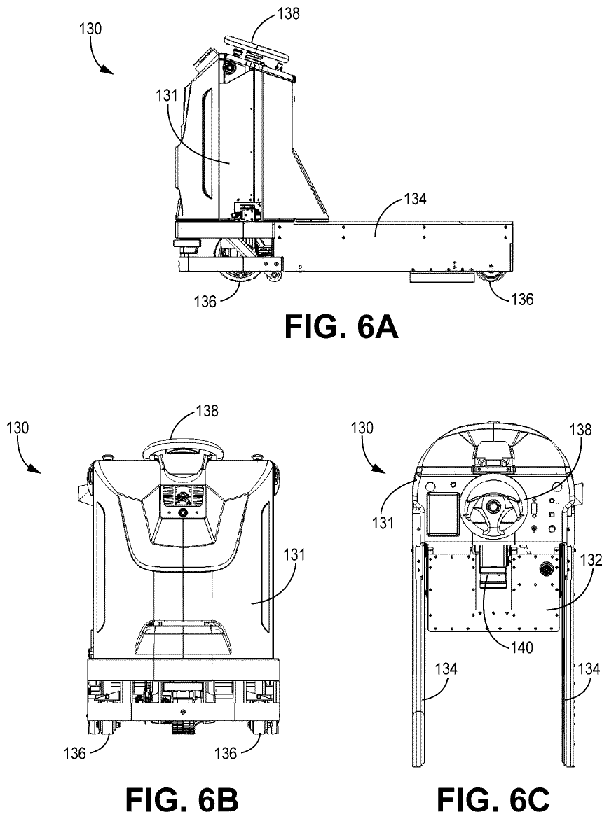

One exemplary autonomous powered vehicle 130 is depicted in FIGS. 6A-6C. The vehicle 130 has a body 131, a deployable base 132 attached to the base 131 and on which a user/operator can stand, wings (or “arms”) 134 extending proximally from the body 131, wheels 136 rotatably coupled to the body 131 and the wings 134 as shown, and an optional steering wheel 138 for a operator to use when the vehicle 130 is in the non-autonomous mode. In addition, the vehicle 130 has a hitch 140 to which the attachable carts discussed elsewhere herein can be removably attached.

Alternatively, the various system embodiments disclosed or contemplated herein can utilize any known autonomous or manually-controlled powered vehicle 122, including the apparatus that can transport carts or other types of trailers as disclosed in the '771 Patent, which is incorporated above. In an alternative specific example, the powered vehicle 122 is an autonomous version of the apparatus of the '771 Patent. In a further alternative, the powered vehicle 122 can be any known self-propelled or manually-propelled vehicle-and can either be autonomously or manually controlled-that can move about and operate in a facility of interest. Regardless of the vehicle 122, it is understood that the vehicle 122 can be attachable to any of the attachable carts disclosed or contemplated herein such that the vehicle can transport such carts around the target facility/building.

In certain embodiments of the system 110, the powered vehicle 122 (including vehicle 130) can have an on-board processor and software similar to the processor 116 and software described above. Alternatively, the information capturing and processing software as described elsewhere herein can be disposed on the server 116. In a further alternative, the software can be disposed on both the on-board processor and on the server 116.

The various cart embodiments will now be discussed in additional detail, including both the multifunctional cart implementations and the interchangeable cart implementations.

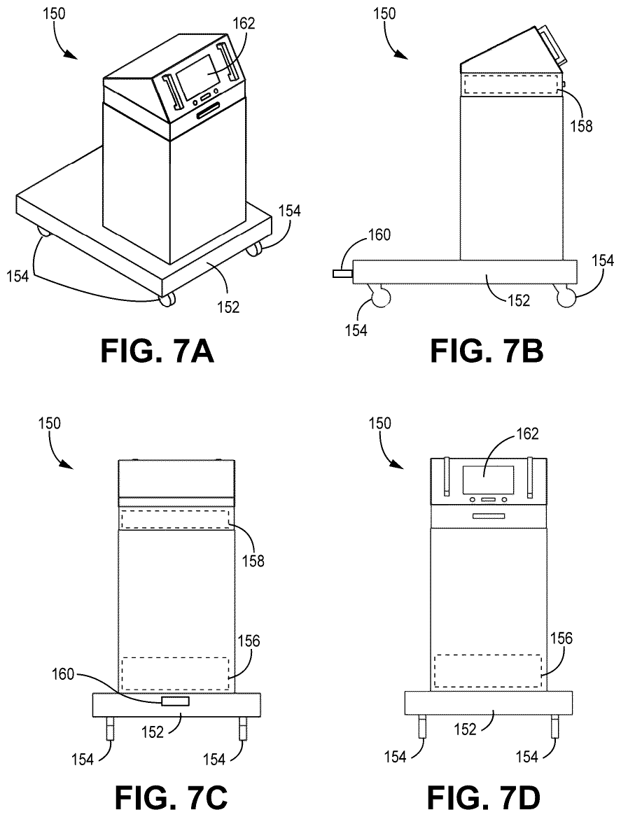

In one example, a basic configurable, multifunctional cart 150 according to one specific, non-limiting embodiment is depicted in FIGS. 7A-7D. The cart 150 has a base 152, wheels 154 rotatably attached to the base 152, a battery 156 (as best shown in FIGS. 7C and 7D), a processor 158 (as best shown in FIGS. 7B and 7C), a hitch 160 for attachment to a powered vehicle (such as the vehicles discussed elsewhere herein) (as best shown in FIGS. 7B and 7C), and a user interface 162 (as best shown in FIGS. 7A and 7D) coupled to the processor 158 for controlling the cart 150 and/or the information collection related thereto. It is understood that the cart 150 can also have various other components thereon depending on the desired functionality. For example, in one embodiment, the cart 150 can also have a collection apparatus (not shown) substantially similar to the various collection apparatuses (such as, for example, collection apparatus 8 discussed above) disclosed or contemplated elsewhere herein. The user interface 162 (which can be, for example, a touchscreen pad 162) can be used by an operator to communicate with the processor 158 and/or the full system 110. The battery 156 is coupled to the other components such that the battery 156 provides power thereto. In addition, motors (not shown) are provided that are coupled to the various other possible components (such as, for example, the collection apparatus-not shown-discussed above) to operate those various components and any other moving parts thereof.

The on-board processor 158 is coupled to the server of the overall system (such as server 116 discussed above with respect to FIG. 5) via a wireless connection such that any information collected via the processor 158 can be transmitted or otherwise transferred to the server. The information collected by the processor 158 can include any information initially collected via the interface 162 and/or any sensors or data collectors (not shown) of any kind on the cart 150, depending on the variable configuration of the cart 150 as discussed in additional detail below. Further, it is understood that any information collected at the cart 150 in any way or via any device/component disclosed or contemplated herein is transferred to the on-board processor 158 and/or to the server (such as server 116) in any known fashion such that software can process the information and then store that information as described elsewhere herein.

As mentioned above, in certain embodiments, the cart 150 can have a collection apparatus (not shown) that is coupled to the processor 158 in a fashion similar to the processor 30 as discussed in detail above and can function in a similar fashion to process the electronic information captured by the cameras (not shown) and/or the reader (not shown) of the collection apparatus (not shown) and process the information to identify the information captured on the target items. As such, the cameras and the reader (not shown) function to capture information/images in the fashion described above, including item information, barcode information, and/or empty space information, for example. It is understood that the collection apparatus (not shown) can have components that are similar to corresponding components in the apparatus 8 above and have substantially similar functions and features. For example, the collection apparatus (not shown) can have at least one digital camera and at least one RFID reader (not shown) both attached to an extendable mast (not shown). The features and functionality of those components are substantially similar to those discussed above and are also non-limiting in the same fashion as those components (various other configurations are contemplated).

As shown, it is understood that the basic configurable multifunctional cart 150 embodiment as shown has fundamental components necessary for operation of the cart 150 regardless of the desired configuration and/or functionality. That is, the processor 158, interface 162 and other components are found in every version of the cart 150 and operate in conjunction with the other configurable components that can be removably attached or incorporated into the cart 150. For example, the cart 150 in various configurations can have one or more temperature sensors, location sensors, speed sensors, cameras, other sensors/data collection devices, lights, etc.

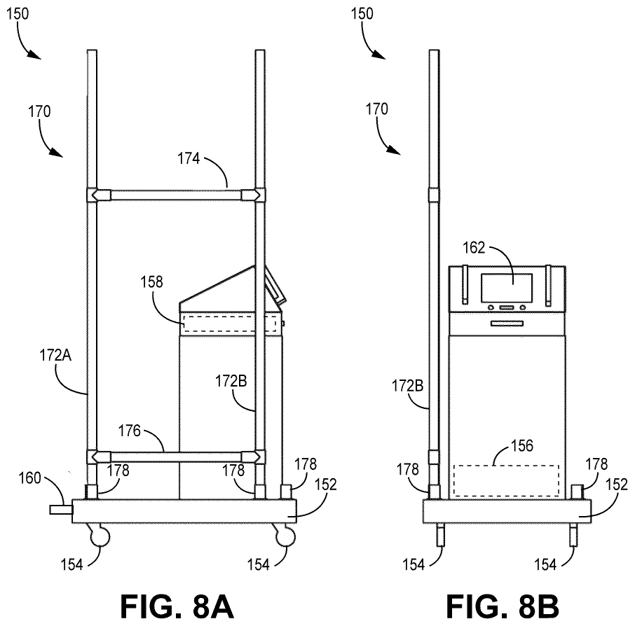

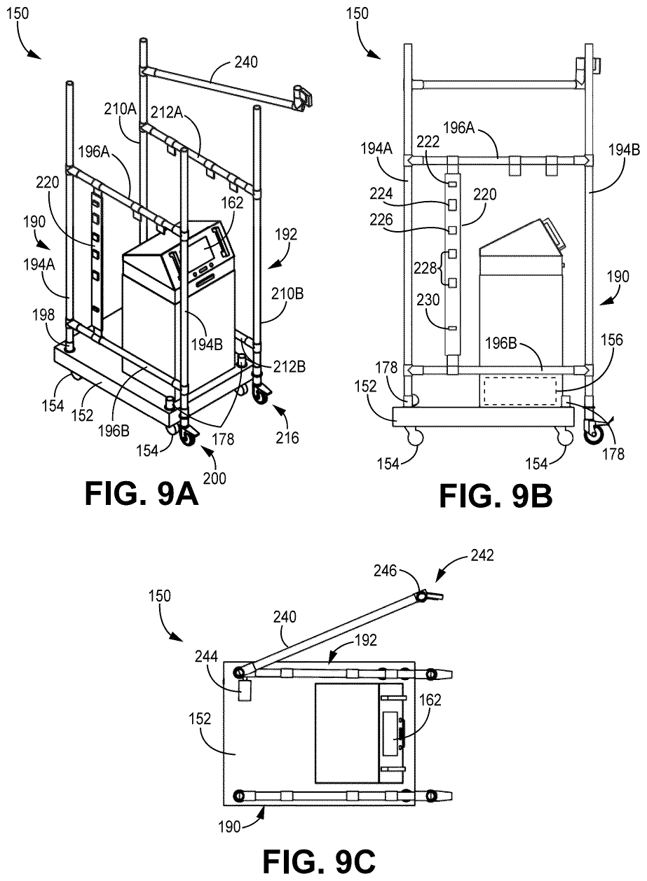

Another embodiment of the cart 150 is depicted in FIGS. 8A and 8B, in which the cart 150 has a removable, adjustable scaffold (or “frames”) 170 that can be attached to the cart 150 to receive various components for use with the cart 150, including any of the sensors or other components discussed elsewhere herein. The scaffold 170 in this specific, non-limiting embodiment has first and second vertical legs (or vertical “bars” or “tubes” or “elongate structures”) 172A, 172B that can hold one or more detachable horizontal arms (or horizontal “bars” or “tubes” or “elongate structures”) 174, 176 that can be attached at various locations along the height of the legs 172A, 172B. It is further understood that is it also possible to provide other structures that are attachable to the scaffold 170, including one or more bars (not shown) that extend between the two of the arms (such as arms 174, 176) and/or bars (not shown) that extend between two scaffolds (not shown) removably attached to the cart 150. In one embodiment, the cart base 152 has sockets (or “female connectors”) 178 disposed on or otherwise attached to the base 152 such that one or more scaffolds 170 can be attached to the base 152 via the sockets 178. In one embodiment, the cart 150 has four sockets 178, with one disposed in each corner of the base 152. Alternatively, the base 152 can have two, three, five, or any number of sockets 178 depending on the number and configuration of the scaffolds that can be attached thereto. In a further alternative as best shown in FIGS. 9A-9C and discussed in detail below, one of the legs of the scaffold 170, instead of being coupled or otherwise attached to the base 152, can have a wheel disposed on the end such that the wheel can be in contact with the surface on which the cart 150 is disposed. It is understood that any of the various components for the configurable cart embodiments herein can be disposed on, removably attached to, integral with, or otherwise associated with any portion of the scaffold(s) 170 (including either or both of the legs 172, 172B and the arms 174, 176) as needed to perform the desired functionality.

Various sensors and other instruments can be removably attached to the horizontal elongate structure 174 or the vertical elongate structures 172A, 172B such that the selected instruments can perform the desired function depending on the specific purpose of the configuration, as discussed elsewhere herein. In other words, depending on the desired functionality/activity (such as security, disinfection, item tracking, and any other functionality/activity as discussed elsewhere herein), the appropriate instruments/devices can be attached to the scaffold(s) 170 to perform that desired activity. For example, the instruments can include, but are not limited to, shelf-scanning and/or inventory cameras, cameras and/or sensors for detecting slip and fall situations, UV light for disinfection (including lights directed downward to disinfect the floor and/or lights directed outward/horizontally to disinfect adjacent shelves/objects), temperature sensors, security cameras, a barcode reader, an RFID reader, and/or any other known sensor, detection device, or instrument for collecting information in a large area or retail or warehouse setting.

In one exemplary implementation, the configurable multifunctional cart 150 can be configured to disinfect a large area/building, as depicted in FIGS. 9A-9C, according to one exemplary, non-limiting embodiment. In addition to the structures, components, and features of the basic cart 150 as discussed in further detail above (and will not be discussed in detail with respect to this embodiment except to the extent that any of those components differ), the cart 150 has two removable scaffolds 190, 192 removably attached to the base 152. The first scaffold 190 in this specific, non-limiting embodiment has first and second legs 194A, 194B that has two detachable arms 196A, 196B that can be attached at various locations along the height of the legs 194A, 194B. The first leg 194A is removably attached to the base 152 at a socket 178, while the second leg 194B has a wheel 200 disposed at its distal end. The second leg 194B is longer than the first leg 194A such that the wheel 200 of the second leg 194B is disposed at substantially the same horizontal height as the wheels 154 of the cart 150 such that the wheel 200 is in contact with and is rollable along the same surface that the cart 150 is disposed on. As such, the wheel 200 and the leg 194B provide additional support and stability to the scaffold 190 and the cart 150 as a whole to help prevent the cart 150 from tipping over as a result of being “top heavy.” Similarly, the second scaffold 192 has first and second legs 210A, 210B that has two detachable arms 212A, 212B that can be attached at various locations along the height of the legs 210A, 210B. The first leg 210A is removably attached to the base 152 at a socket (not shown), while the second leg 210B has a wheel 216 disposed at its distal end. The second leg 210B is longer than the first leg 210A such that the wheel 216 of the second leg 210B is disposed at substantially the same horizontal height as the wheels 154 of the cart 150 such that the wheel 216 is in contact with and is rollable along the same surface that the cart 150 is disposed on. As such, the wheel 216 and the leg 210B provide additional support and stability to the scaffold 192 and the cart 150 as a whole to help prevent the cart 150 from tipping over as a result of being “top heavy.”

In addition, in this specific implementation, the scaffold 190 also has an additional attachable vertical elongate structure (or “bar”) 220 that is attached at one end to the first arm 196A and at the other end to the second arm 196B as shown. As best shown in FIG. 9B, the attachable bar 220 in this embodiment is a sensory array bar 220 that can have one or more instruments or devices attached to or otherwise disposed on the bar 220. In this specific example, the bar 220 has a camera 222, an RFID reader 224, a temperature sensor 226, a UV light array 228, and a floor-scanning camera 230. Alternatively, any configuration of instruments can be incorporated into or disposed on the bar 220, so long as, for purposes of the disinfection cart configuration, it includes at least one UV light on the bar 220 or elsewhere on at least one of the scaffolds 190, 192.

Further, this exemplary embodiment also includes a deployable arm 240 rotatably attached to the scaffold 192. More specifically, the arm 240 is rotatably attached to the first leg 210A such that the deployable arm 240 can rotate around the longitudinal axis of the leg 210A as shown in FIGS. 9A and 9C. In one implementation, the arm 240 can rotate between a retracted position in which the distal end of the arm is attached or otherwise coupled to the leg 210B and an extended or deployed position in which the arm 240 rotates away from the cart 150. FIG. 9C depicts the deployable arm 240 disposed in a position between the retracted position and the deployed position. At the distal end of the arm 240 is a UV light array 242. The UV light array 242 is attached to the deployable arm 242 such that the lights in the array 242 are directed away from the cart 150. According to one embodiment, the light array 242 can have shields (not shown) disposed on both sides of the array 242 such that the shields (not shown) direct or “focus” the light emitted therefrom in the desired direction.

In accordance with certain implementations, as best shown in FIG. 9C, the scaffold 192 also has an actuator (typically a motor) 244 that is coupled to the leg 210A and/or the deployable arm 240 such that the actuator 244 provides the force to move the arm 240 between its retracted and extended positions. In addition, the arm 240 can have a proximity sensor 246 disposed at or near the distal end of the arm 240 such that the sensor 246 can be used to detect when the arm 240 is approaching an object while being urged toward its extended position.

In accordance with certain implementations, the deployable arm 240 also has a vertical extension feature such that the arm 240 can also be actuated between a lowered and a raised position (not shown) such that the light array 242 can be positioned at a greater height to disinfect the target surfaces/objects disposed at a greater height than the physical height of the unextended arm 240 on the cart 150.

Similarly, according to certain embodiments, there are UV lights disposed on the underside along the length of the arm 240 and further can be disposed on the underside of the base 152 (with appropriate shields (not shown) in certain implementations) that are directed downward toward the floor to disinfect the floor over which the cart 150 passes. In addition, UV lights can also be provided on a top side of the arm 240 and/or other top surfaces of the cart 150 and/or scaffolds 190, 192 to emit the UV light upward to reduce or eliminate airborne pathogens in the ambient air above the cart 150.

Further, in accordance with various alternative implementations, the rotatable arm 240 can also be extendable. That is, the rotatable arm 240 can have an extendable section that can be urged between a retracted position and an extended position by the actuator 244 or a separate actuator (not shown).

Further, it is understood that, in accordance with certain embodiments, the scaffold 190 can also have a deployable arm (like arm 240) and the various additional features and components as described herein. In a further alternative, it is also understood that the scaffold 192 can also have an attachable bar similar to bar 220. It is further understood that either or both of the scaffolds 190, 192 can be coupled at both legs 194A, 194B, 210A, 210B to the base 152 via sockets 178 and not have any wheels disposed on the distal ends thereof.

The on-board processor 156 is coupled to the arm 240 and the light array 242 such that the processor 156 (or the server 116, or both) can communicate with and control the arm 240 and light array 242 to operate in the fashion described herein. Further, the processor 156 and/or the server 116 can collect information about the cart 150 and the components thereof during operation, including the time at which a particular location is disinfected, the speed of the cart 150 at any given time, the intensity of the lights in the light array 242 (or elsewhere on the cart 150), the position of the arm 240, and any other relevant information relating to the operation of the cart 150 and the disinfection of the desired area. Thus, the collected information can be used to confirm the successful disinfection of the area(s) covered by the cart 150 during any period of operation. More specifically, the information is transported to the on-board processor 156 and/or to the server 116 such that software can process the information to determine whether disinfection of a specific area was successful and then store that information in the database 118 in a fashion similar to that described in other embodiments above.

In one embodiment, the lights in the array 242 (and any other lights on the cart 150) emit ultraviolet (“UV”) light. In certain more specific implementations, the lights emit UV-C light, which has a wavelength ranging from 100 to 280 nm. Alternatively, the lights can emit any known light that can disinfect objects and/or the ambient air.

In use, the configurable cart 150 that is configured as a disinfection cart 150 as shown in FIGS. 9A-9C can be attached to an autonomous powered vehicle (such as vehicle 130, for example) and transported along the aisles of the facility. More specifically, the desired route can be inputted into the processor (not shown) of the autonomous vehicle. Once the vehicle is ready to proceed, the processor (not shown) of the vehicle 130 can communicate with the processor 156 of the cart 150 (either directly or via the system 110) to actuate and coordinate the operation of the disinfection cart 150 (and the arm 240 and lights) during transport of the cart 150 along the desired route. As such, the combination of the vehicle and the cart 150 can operate to disinfect the target areas.

When the cart 150 is disposed in the desired location in the target aisle(s), the deployable arm 240 (or arms) is actuated (by the processor 156 transmitting signals to the actuator 244 to move into its deployed position as best shown in FIG. 9C. The arm 240 extends out until it is within a predetermined distance from the shelves (or doors, or any other objects that define the borders of the aisle). At that point, the proximity sensors 246 disposed on the distal end of the arm 240 detect that the arm 240 is disposed within a predetermined distance from the border of the aisle (or other object) and transmit that information to the processor 156 such that the processor 156 transmits instructions to stop the further extension of the arm 240. It is understood that any predetermined distance can be inputted into the processor 156 for purposes of positioning of the distal end of the arm 240 in relation to the shelves or other objects.

In addition, the lights on the array 242 and elsewhere are actuated by the processor 156 at the appropriate time as well. In one embodiment, the lights are actuated as soon as the cart 150 begins to move. Alternatively, the lights can be actuated once the arm 240 is deployed as desired. In a further alternative, the lights can be actuated at any desirable point during operation.

With a given UV light bulb output, it is understood that the required disinfection dose is directly related to the distance of the bulb from the target surface and duration of the light being applied to that surface. For example, according to one embodiment, a 300 watt bulb can disinfect all or almost all of a surface positioned between about 6 and about 12 inches from the bulb while the bulb (the cart 180) is traveling at a rate of 1 foot per second. It is understood that any of these variables can be adjusted based on the adjustment of the other variables to achieve an equivalent level of success with respect to disinfection. The software in the processor 156 and/or the server 116 can be used to determine the optimal speed for the cart 150 based on the bulb intensity and the distance from the target surface. Further, if either the distance or the bulb intensity changes for some reason, the software can be used to adjust the speed of the cart 150 accordingly. Further, because the cart 150 location is tracked (along with the speed), the software can also be used to confirm or “certify” that a specific location, aisle, or area has been disinfected successfully and provide a time stamp for that disinfection. In addition, the software can also utilize that information in combination with a facility map or layout to generate a report to an operator or facility employee regarding the disinfection status. Further, any of this information or any other information relating to tracking as discussed above can be compiled, processed, and provided in reports generated by the system 110.

Another activity for which the configurable cart 150 (such as the cart 150 of FIGS. 8A and 8B) can be configured is inventory stocking. Thus, the configurable cart 150 of FIGS. 8A and 8B becomes a stocking cart 150. Alternatively, in those embodiments in which the carts are non-configurable and have predetermined and permanent functionality, the attachable cart that can be included in the fleet of carts is a stocking cart (similar to cart 150 in FIGS. 8A and 8B). A stocking cart can simply be a flatbed cart for carrying items to be stocked at or otherwise moved around the facility. In one implementation, the cart 150 of FIGS. 8A and 8B can be the stocking cart 150, with the base 152 serving as the flatbed. In operation, an operator can program or otherwise instruct the autonomous vehicle (such as vehicle 130) to travel along a specific route to transport the stocking cart 150 with specific items disposed on the base 152 to a specific location or series of locations. As such, the items on the cart 150 can be transported to the desired location and then removed from the cart 150 and stocked as desired. In certain implementations, the autonomous vehicle can also autonomously or automatically unhitch from the cart 150 at the desired location such that the cart 150 is left at the desired location and the vehicle then travels to another location or back to the loading dock or other loading location. In further embodiments, the vehicle can be programmed to retrieve an empty cart 150 from the facility floor and transport it back to the loading area.

In another embodiment, the cart 150 of FIGS. 8A and 8B can be used as an item tracking cart 150. That is, the cart 150 can have one or two scaffolds (like scaffold 170) with a collection apparatus (similar to collection apparatus 8) disposed on one or both of such scaffolds. The collection apparatus can have substantially the same components and operate in substantially the same fashion as the apparatus 8 discussed above. As such, the cart 150 can be operated in a fashion similar to the tracking vehicle embodiments discussed above. More specifically, an operator can input a desired route into the autonomous vehicle (such as vehicle 130). Once the vehicle is ready to proceed, the processor (not shown) of the vehicle 130 can communicate with the processor 156 of the cart 150 (either directly or via the system 110) to actuate and coordinate the operation of the collection apparatus during transport of the cart 150 along the desired route. As such, the combination of the vehicle and the cart 150 can operate in a fashion similar to the 84 embodiments discussed in further detail above.

It is understood that the various embodiments herein can include methods and systems for utilizing a single autonomous vehicle with no cart, a single configurable cart (such as cart 150 of FIGS. 8A-8B), or two or more interchangeable attachable carts such that the interchangeable cart can be selected based on the desired functionality. Thus, after hours, the autonomous vehicle can be attached to a disinfection cart (such as configurable cart 150 as configured in FIGS. 9A and 9C) and instructed to transport the cart in a coverage pattern that causes it to move through and disinfect all the aisles of the facility overnight. Alternatively, on nights when sterilization is unnecessary, the autonomous vehicle can be attached to a tracking cart (such as configurable cart 150 configured for tracking as described above, for example) and instructed to move through the facility in a coverage pattern such that it can detect, identify, and track each item therein in a fashion similar to that described elsewhere above. In a further alternative, either of these procedures can be performed during normal business hours as needed or as possible. Yet another alternative involves attaching the autonomous vehicle to a configurable cart configured as a stocking cart (or an interchangeable stocking cart) to transport items from an exterior location (such as a loading dock) to the location where the item is to be placed within the facility. It is further understood that the fleet of vehicles and carts can include at least two autonomous vehicles and at least one configurable cart or at least three interchangeable carts (at least one each of a tracking cart, a disinfection cart, and a stocking cart) for each such vehicle. Alternatively, any number of autonomous vehicles and carts can be provided.

In certain alternative embodiments, the one or more autonomous vehicle has the tracking, transporting, and/or sterilization features built into the vehicle such that the attachable carts are unnecessary. In another alternative, one attachable or configurable cart can incorporate at least two of the stocking, tracking, and/or sterilization components/features thereon. For example, a combination tracking and disinfection cart could perform both functions at the same time. Alternatively, any combination of stocking, tracking, and/or disinfection could be provided in any cart to create double or triple purpose while reducing time requirements.

The various embodiments herein can be incorporated into a single robotic platform in which a single robotic guidance system (an autonomous vehicle according to any of the embodiments herein) can be “shared” by one or multiple cart configurations that meet the specific needs of the user in a large space. Such a robotic platform can be leveraged in many ways to perform multiple different activities.

In one non-limiting example, an autonomous vehicle can be coupled to an inventory stocking cart (or the configurable cart configured as such) and used in the location from, for example, 5 AM to 9 AM to deliver inventory for restocking. After 9 AM, the autonomous vehicle can be coupled to a tracking cart (or the configurable cart can be configured as a tracking cart) and travel a specified route to take inventory of the space or track the objects on the shelves. Alternatively, or later, the autonomous vehicle can be coupled to a cart for scanning aisles for slip and fall situations or cleanliness (or the cart 150 can be configured as such) and travel a specified route. Alternatively, the cart 150 can be configured to perform all three activities. And in this example, after 9 pm, the autonomous vehicle can be coupled to a disinfection cart (or the configurable cart can be configured as a disinfection cart) and travel a specified route to disinfect the space.

Alternatively, the cart 150 can be configured to perform any of the functions described elsewhere herein, including completing temperature checks or other tasks, simply by adding the required sensors, cameras, lights, or other instruments.

With respect to any of the embodiments or activities disclosed or contemplated herein, the information collected can be both stored onboard (in the processor 156, for example, or some onboard database coupled thereto) and/or communicated via a network (such as network 114) (via wifi or cellular communications or any other wireless technology) to a database (such as database 118) where the information can be analyzed and reported. As mentioned above, any cart (such as cart 150) herein can be configured with sensors to collect information about the cart's location, speed, and with timestamps, automate the tracking, verification, and reporting of these activities. For example, the tracking and reporting of disinfection is described in further detail above.

As such, the various system embodiments herein provide for the ability to robotically complete multiple critical tasks to maintain the health and safety of an environment. Those tasks are monitored, tracked, and reported using the onboard computer and communications system. That system enables near real-time reporting capabilities for a single or multiple tasks, including reporting such information to a single dashboard.

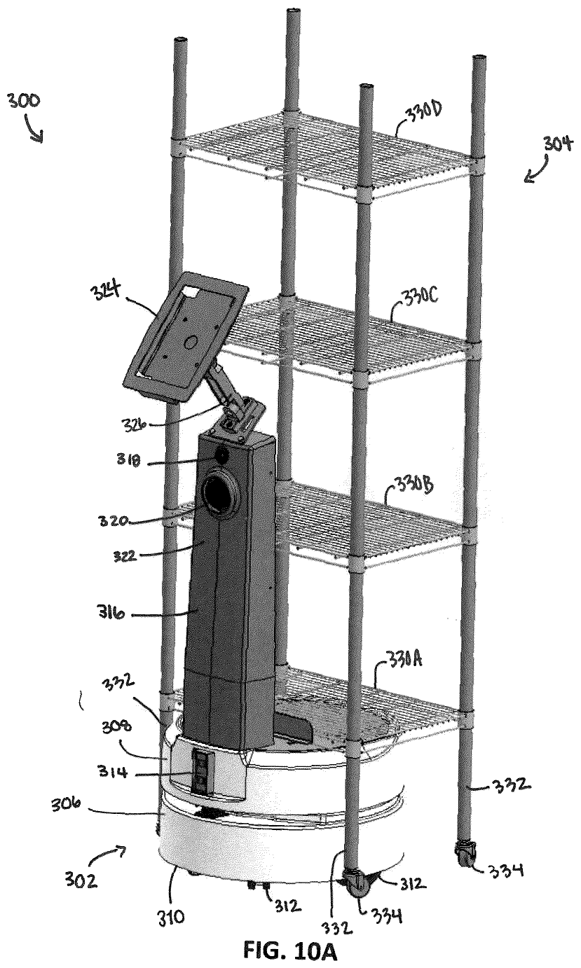

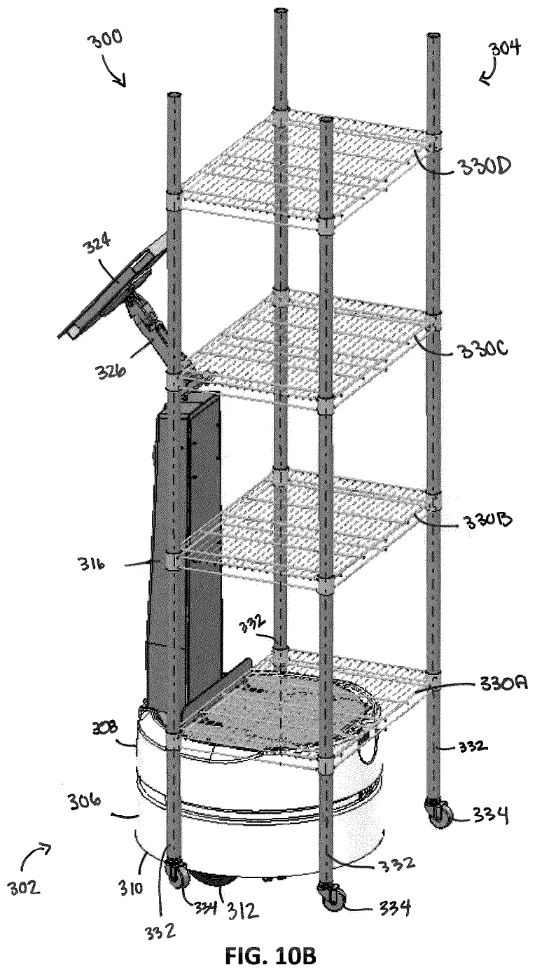

FIGS. 10A and 10B show another exemplary embodiment of the multifunctional area management system 300. The system 300 can be configured to move inventory throughout a multifunctional space. That is, the system 300 can track and move products to assist in restocking retail areas or other areas of a multifunctional indoor or outdoor space. The system 300 includes an autonomous prime mover (also referred to as an “autonomous vehicle”) 302. The prime mover 302 as described below is a vehicle or transportation apparatus 302 substantially similar to the various vehicles (such as vehicle 10, vehicle 42, vehicle 60, vehicle 80, vehicle 122, or vehicle 130) described in detail herein. Some embodiments of the system 300 can also include a cart 304 that can couple with the autonomous vehicle 302.

The prime mover 302 can include a prime mover base 306. In this specific implementation, the prime mover base 306 can include an upper portion 308 and a lower portion 310 disposed below the upper portion 308. The lower portion 310 can include a plurality of wheels 312 disposed on the bottom of the lower portion 310 as shown. The upper portion 308 can include a charging port 314 and can be configured to receive the cart 304 such that the cart is attachable to the base 306 at the upper portion 308, as will be described in further detail below. Alternatively, the base 306 can be made up of solely a single unit or portion, rather than two portions. In the specific implementation as shown, the base 306 has a cylindrical shape. Alternatively, the base 306 can have any shape so long as it allows for attachment of a cart such as cart 304 thereto.

A prime mover mast 316 can be disposed on the upper portion 308 of the prime mover base 306. As used herein, the term “mast” is intended to mean any body 316 that is attached to the base 306 and extends vertically upward from the base 306. The mast 316 can include a variety of sensors, including, for example, a sensor 318 disposed on the external side of the mast 316 (the side facing away from any cart coupled to the base 306) near a top end of the mast 316. In addition, according to some embodiments, the mast 316 can include at least one camera 320. In this specific implementation, the camera 320 is also disposed on the external side of the mast 316 near a top end of the mast 316. Alternatively, the sensors 318 and/or camera 320 can be disposed anywhere on the mast 316. The positioning of the camera 320 and/or sensors 318 can be such that the camera 320 and/or sensors 318 can capture images and/or data in an area adjacent to the mast 316 within the field of view of the camera 320 and/or sensors 318. Alternatively, the mast 316 can have any other information collection device according to any of the other autonomous vehicle embodiments discussed above, including an RFID reader or the like. Further, the vehicle 302 can operate in a fashion similar to any of the vehicles described above to collect information about and track various items within a predetermined location.

The mast 316 can be configured to house an interface (not pictured). For example, in some embodiments, the mast 316 includes a frame 324 attached to the mast 316. According to one implementation as shown, the frame 324 is attached to the top of the mast 316 via an arm 326. In some embodiments, the arm 326 is adjustable such that the height and/or angle of the frame 324 can be adjusted via the arm 326. Alternatively, the frame 324 can be attached to any location on the mast 316 that is readily accessible to a user. In some embodiments, the frame 324 can be configured to hold an interface such as a tablet (not pictured) therein. The interface housed within the frame 324 can be used to deliver commands and/or conduct operations associated with the system 300 (discussed in further detail below).

As best shown in FIG. 10B, according to one embodiment, the cart 304 can include multiple shelves 330A-330D configured to hold products or other items thereon. The cart 304 can include a base shelf 330A, which can be the bottom-most shelf 330. The shelves 330 can be upheld via a plurality of legs 332. In some embodiments, the cart 304 can have four legs 332. Wheels 334 can be disposed on the bottom of the cart legs 332. The base shelf 330 can be the shelf nearest the cart wheels 334. In addition, a plurality of shelves 330B-330D can be disposed above the base shelf 330A. The cart 304 can have any number of shelves 330A-D as needed for the particular location where the system 300 is in use and the type of items being transported thereon.

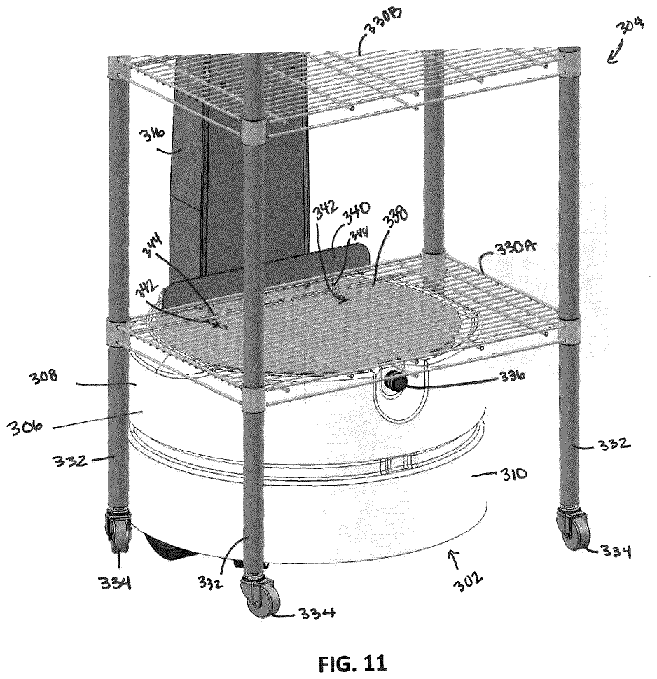

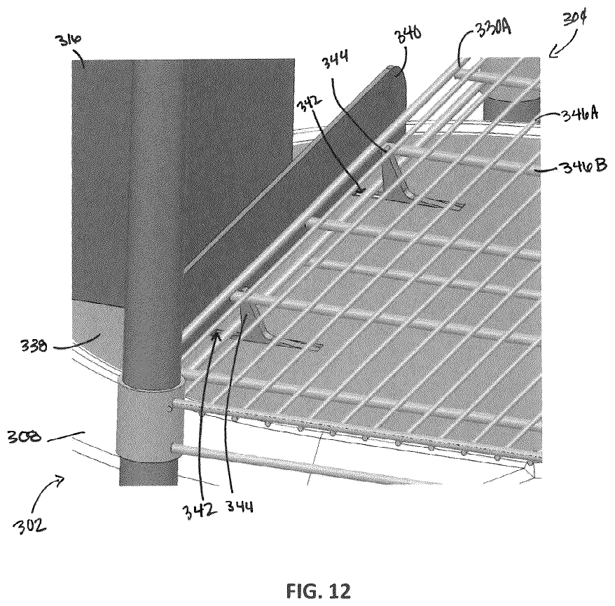

In accordance with one implementation, FIGS. 11 and 12 provide closeup views of the lower portion of the cart 304 coupled to the autonomous prime mover base 306. When the cart 304 is coupled to the prime mover base 306, the cart base shelf 330A can be disposed above and/or in contact with the prime mover base 306.

As can be seen in FIGS. 11 and 12, according to one embodiment, the upper portion 308 of the base 306 can include a cover 338. The cover 338 can be removably disposed on the top of the upper portion 308 of the base 306 such that the cover 338 can provide access to the internal components of the base 306. Thus, when a cart 304 is coupled to the base 306 as shown, the cover 338 is disposed below the base cart shelf 330A. In certain implementations, the cover 338 can include a backstop 340 attached to the top surface of the cover 338. The backstop 340 can be a flange 340 or any other similar structure that extends across at least a portion of the top surface of the cover 338 as shown. In one embodiment, the backstop 340 is positioned on the cover 338 such that when the cover 338 is disposed in place on the base 306, the backstop 340 is disposed adjacent to or in contact with the mast 316 as shown. As shown in FIGS. 11 and 12, when the cart 304 is coupled to the base 306, the base shelf 330A can abut and/or be disposed adjacent to the backstop 340 of the cover 338.

In addition, the cover 338 can also include two openings 342 defined in the cover 338, according to one embodiment. Alternatively, the cover 338 can have three, four, five, six, or any number of openings 342. The two openings 342 are defined in the cover 342 such that they can receive the two latches 344A, 344B of a coupling mechanism 350 described in additional detail below. The latches 344A, 344B can pass through the openings 342 (and protrude out of the openings 342 as shown) and thereby attach the cart 304 to the base 306 of the autonomous prime mover 302.

In addition, as best shown in FIG. 11, the base 306 can include an emergency stop button 336. While the button is depicted on the top portion 308 of the base, this illustration is not intended to be limiting; the emergency stop button 336 can be positioned anywhere on the base 306 that provides for easy access to the button 336. For example, should the shape, structure, or position of the cart 304 obstruct access to the button 336 in its depicted location, the button 336 can instead be positioned at another location on the base 306 to allow access to the button 336. This alternative location can be anywhere on the autonomous prime mover base 306, including, for example, anywhere on the sides of either of the upper or lower portions 308, 310 of the autonomous prime mover base 306.

Coupling the cart 304 to the autonomous prime mover 302 can include coupling the coupling mechanism 344 to the base shelf 330A. In some embodiments such as that shown in FIGS. 11 and 12, the base shelf 330A can be a wire shelf and the coupling mechanism 350 can include two latches 344A, 344B intended to be placed in contact with the shelf 330A. More specifically, the wire shelf 330A can include a plurality of wires 346A oriented generally parallel to the backstop 340 and another plurality of wires 346B oriented generally perpendicular to the backstop 340. Thus, as best shown in FIG. 12, when the cart 304 is positioned such that the base shelf 330A is disposed over the base 306 of the prime mover 302 and in contact with and/or adjacent to the backstop 340, the latches 344 can extend upward and be disposed between and in contact with two parallel wires 346A of the shelf 330A. In addition, in certain implementations, the latches 344A, 344B can be positioned such that they are disposed adjacent to and/or in contact with two perpendicular wires 346B of the shelf 330A.

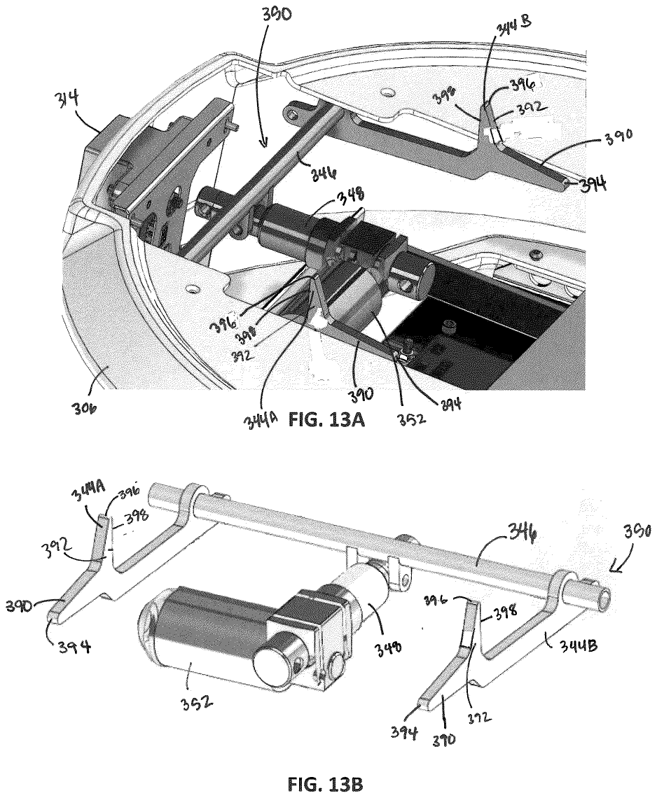

FIGS. 13A and 13B show the coupling mechanism 350 within the autonomous prime mover base 306, according to one embodiment. The two latches 344A, 344B are coupled to and extend from the latch bar 346 such that the latches 344A, 344B are configured to move between a deployed or latching/latched position (as shown in FIGS. 11, 12, and 13A) and a retracted or unlatched position (not shown) as a result of the rotation of the latch bar 346. The latches 344A, 344B are tensioned (also referred to as “spring-loaded”) such that they are urged upward toward the latching/latched position unless or until a user depresses a latch release lever or pedal to overcome the force urging them upward, thereby urging the latches 344A, 344B downward toward the retracted position.

In one implementation, at their distal ends, both latches 344A-B have a distal (or horizontal) projection 390 and a vertical projection 392. The distal projection 390 has a narrow tip 394 and a thickness that progressively increases from the tip 394 to the vertical projection 392. As the two latches 344A, 344B make contact with the base shelf 330A, the narrow tip 394 causes the distal portion of the distal projection 390 to be positioned beneath the base shelf 330A. And as the two latches 344A, 344B move forward (or as base shelf 330A moves toward the latches 344A-B), the increasing thickness of the projection 390 causes the top portion of the distal projections 390 to make contact with the base shelf 330A such that the latches 344A, 344B are urged downward as the latches 344A, 344B are urged forward or as the shelf 330A is urged toward the latches 344A-B. This urging of the latches 344A, 344B downward as they are urged forward continues as the vertical projections 392 make contact with the base shelf 330A. The slope of the distal projection 390 and the upward projection 392 allow for this urging of the latches 344A, 344B downward (toward their retracted positions) as the latches 344A, 344B are urged forward. Once the tip 396 of the upward projection 392 moves past a horizontal wire 346A of the base shelf 330A, the latches 344A, 344B are no longer restrained along the top of the distal projection 390 or upward projection 392 by the horizontal wire 346A, so the latches 344A, 344B move back toward the latched position. At this point, the base shelf 330A is retained proximal to the latches 344A, 344B by the back surface 398 of the upward projection 392.

Thus, in use, to couple the cart 304 to the prime mover 302, the cart 304 can be rolled over the prime mover base 306, or the prime mover 302 can be moved into position in relation to the cart 304 such that the base 306 is disposed under the cart 304 as shown in FIGS. 10A-12. When the cart 304 is rolled over the prime mover base 306 or the base 306 is positioned under the cart 304, the two latches 344A, B can be pushed down by the base shelf 330A of the cart 304 as described above. Particularly, the parallel wires 346A of the shelf 330A can push down the latches 344A-B toward their retracted positions while being urged toward the backstop 340. When the shelf wires 346A pass over the latches 344A, 344B, the latches 344A-B can return to their original deployed position (as a result of the spring-loaded nature of the latches 344A-B) as also described above such that the projections 344A, 344B are disposed between two wires 346A of the wire shelf 330A. A plurality of the parallel wires 346A can pass over the latches 344A-B until an edge of the shelf 330A abuts the backstop 340. It should be noted that the type of shelf is by no means limiting. The coupling mechanism 344 can be used in combination with any type of shelf 330 coupleable to the latch mechanism 344.

Turning to the rest of the coupling mechanism 350, the rotatable latch bar 346 can be coupled with an actuator 348. The actuator 348 can be operably coupled with a motor 352 (best shown in FIG. 13B). Operation of the motor 352 can cause linear movement of the actuator 348 such that the actuator 348 acts like a piston. Linear movement of the actuator 348 causes rotational movement of the latch bar 346, thereby moving the latches 344A, 344B upward or downward depending on the direction that the latch bar 346 rotates. In one exemplary embodiment, the latches 344A, 344B are disposed in their resting position in their deployed or latching position and the motor 352 and actuator 348 are configured to cause the latch bar 346 to rotate such that the latches 344A, 344B are urged downward into their retracted position. Thus, when a user or the system wants to uncouple the base 306 from the cart 304, the motor 352 can be actuated to cause the latches 344A, 344B to move into their retracted positions. And once the cart 304 has been uncoupled, the latches 344A, 344B are allowed to return to their latching position.

In use, the system 300 can be used to transport products or other items (not pictured) throughout a multifunctional area. The multifunctional area can be a building or location such as a store or a warehouse. Alternatively, the multifunctional area can be any building or location of any kind having items for transport therein. While the items described herein will generally be referred to as “products,” the various system embodiments herein can be used to transport any types of items that might need to be moved around an area, building, or location. For purposes of transport, the products can be disposed on a cart 304 attached to the autonomous prime mover 302. In other embodiments, the products can be disposed directly on the autonomous prime mover 302 for transportation. In some examples, the mast 316 can include a plurality of hooks (not pictured). Products can be loaded into containers, and the containers can be placed on the hooks for transport.

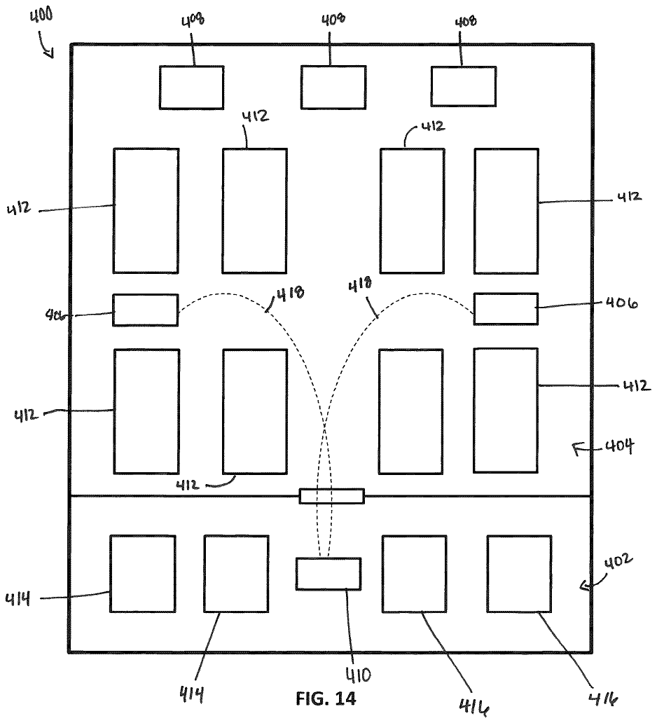

FIG. 14 shows an illustrated, exemplary multifunctional space 400. In this specific implementation, the multifunctional space 400 is a retail store having a retail area 404 and a storage area 402. The retail area 404 is configured for customers to browse and shop various items and/or services offered by a store. The storage area 402 can be used to store inventory prior to its sale. This sale can be, for example, from the retail space 404. Alternatively, inventory can be available for sale via e-commerce. In a further alternative, any multifunctional space is contemplated, including any indoor or outdoor space in which items are stocked and/or transported within the space and/or into and out of the space.

Any system disclosed or contemplated herein, including, for example, the system 300 described above, can be configured for use in the multifunctional space 400. That is, the system 300 can maneuver within the multifunctional space 400 to track and transport items within the space 400 as needed. For example, the system 300 can travel from the storage area 402 to the retail area 404 and from the retail area 404 to the storage area 402. The system can collect inventory data while completing such movements, as well as distribute inventory throughout the retail space 404. As such, the system 300 can be used in combination with or as a component of a network-based system such as system 40 discussed in detail above and can incorporate any of the components and/or steps used in system 40 for tracking and transporting items in the multifunctional space 400. Thus, any reference to the operation of the system 300 below also can mean the operation of the systems 300 within a tracking and transporting system such as system 40 or any other such system disclosed or contemplated herein.

In certain implementations, the system 300 can travel a path 418 throughout the multifunctional store space 400. This path 418 can be pre-programmed for the cart 304 to follow. Alternatively, the system 300 can use a variety of sensors and/or GPS to determine a path 418 to take throughout the space 400. Such sensors—such as sensor 318, for example—can be disposed on the autonomous prime mover 302 of the system, as shown in FIG. 10A.

In some embodiments, the multifunctional store space 400 can include delivery locations 406 in the retail area 404 of the space 400 to which the system 300 can travel to deliver items from the storage area 402. The two exemplary delivery locations 406 as shown are strategically positioned at substantially central locations within the retail area 404 such that the items delivered to either location 406 by the system 300 (the vehicle 302 alone or the vehicle 302 and the cart 304) can easily be manually transported by a user from that location 406 to the appropriate shelf or other retail display structure near that location 406 in the retail area 404. Alternatively, the one or more delivery locations 406 can be located at any location in either the storage area 402 or the retail area 404. For example, the delivery locations 406 can be located between shelves 412. In other examples, the delivery locations 406 can be located near point-of-sale locations 408. The number of delivery locations 406 can be one, two, three, four, five, six, seven, eight, nine, ten, eleven, twelve, or any other number of locations 406 depending on the size and/or layout of the retail area 404 and/or the type of items being delivered. According to certain embodiments, the larger the retail area 404, the greater the number of delivery locations 406 positioned in the retail area 404.

Once the system 300 (either the delivery vehicle 302 alone or the vehicle 302 with the cart 304 attached) delivers the items to the appropriate delivery location 406, the system 300 can return to the storage area 402. In certain embodiments, the storage area 402 can include one or more return locations 410 positioned in the storage area 402 to which the system 300 can travel and can be stored or otherwise positioned until it receives a command to return to the retail area 404 or travel elsewhere in the multifunctional space 400. According to some implementations, the return location 410 can include charging or other maintenance equipment for the system 300.

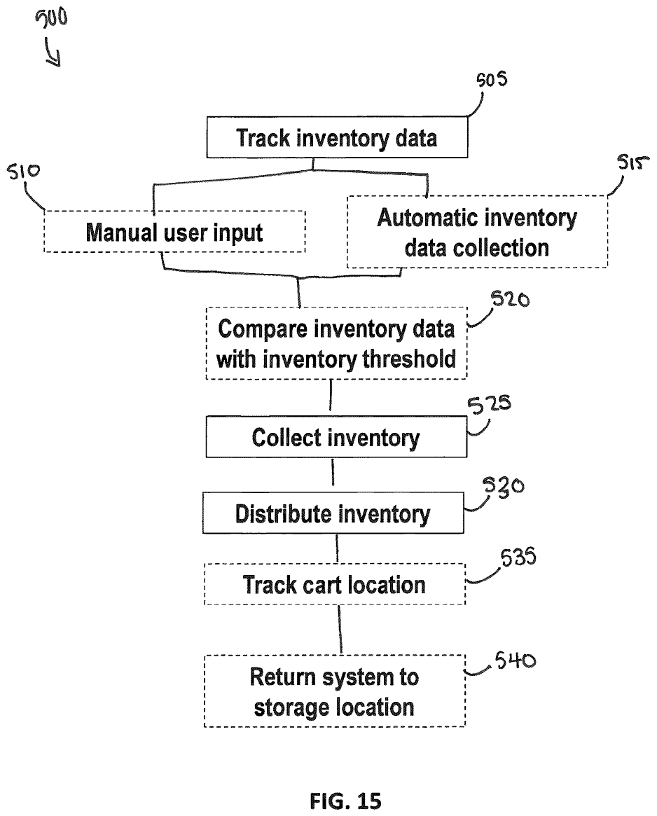

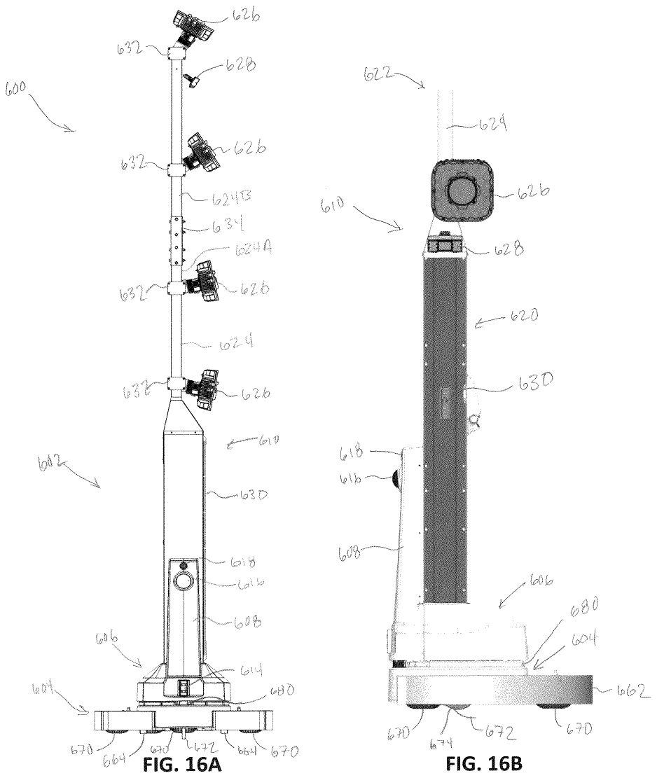

FIG. 15 shows one embodiment of a method of tracking and moving items within a multifunctional location with an autonomous vehicle 500. The method can include tracking a quantity of displayed items in the retail area 404 (block 505) and distributing additional items (or inventory) from the storage area 402 to a predetermined delivery location 406 in the retail area 404 (block 530). In distributing the product, the system (such as system 300) can autonomously move from the storage area 402 to the retail area 404 to deliver products or other items at predetermined locations 406, as shown in FIG. 14. Alternatively, the distributing of inventory (block 530) can relate to the transport of items via an autonomous vehicle (such as vehicle 302) to a predetermined location in the storage area 404.

The method 500 can include tracking inventory data in a variety of ways, including tracking the location of the inventory within a multifunctional location. For example, inventory data relating to various items (such as products) can be inputted manually by a user (block 510), including, for example, the type of item and the location of the item within the location. That is, the user can manually count the total number of items of particular type (or, alternatively, all items) and input that quantity into an interface or program associated with the system (such as a system 40 being used in combination with an autonomous delivery system such as system 300). More specifically, such an input can be done directly on an interface associated with the autonomous delivery vehicle (e.g., such as the vehicle 302 of FIG. 10) or via an application associated with an external device (e.g., a cell phone or tablet) of a system such as system 40. In certain specific embodiments, the user can manually count the total number of items of a particular type (or all items) disposed in the retail area 404 and enter those into the system (such as system 300 and/or system 40). In alternative implementations, the user can manually count the total number of items of a particular type (or all items) disposed in the storage area 402 and enter those into the system (such as system 300 and/or system 40). In yet another embodiment, the user can manually count the total number of items of a particular type (or all items) disposed anywhere in a multifunctional location 400 and enter those into the system.

In other embodiments, the method can include automatic collection of inventory data by the system (block 515). As discussed above with respect to FIG. 10, the autonomous transport system 300 can include a variety of cameras 320, scanners, sensors 318, or any other known data collection devices as described elsewhere herein. In certain embodiments, the vehicle (such as vehicle 302) can autonomously move through the retail area 404, the storage area 402, or both in a manner described above with respect to other embodiments and collect information about the items therein via one or more of the data collection devices. In one specific implementation, the vehicle (such as vehicle 302) autonomously moves through the retail area 404 and collects information about each purchasable item displayed in the retail area 404. Further, the system (such as system 300 in combination with a system like system 40) can also track information regarding sold items via tracking information collected at a point-of-sale location such that the system is able to track when an item is no longer present in the retail area 404 or in the entire area 400 as a whole. Thus, the system can receive information from the device(s) at the point-of-sale location (which are coupled to the system via a network similar to that described above with respect to system 40 or any other such system disclosed or contemplated herein) to track the number of items of a particular type that is sold, thereby tracking the number of such items still displayed in the retail area 404.

In the various system and method embodiments herein, the information collected about each item can include location (whether the item is located in the storage area 402 or the retail area 404, for example), the type of item, the intended delivery location 406 for the item, and any other information that could be relevant or helpful for purposes of using the various system embodiments herein to track and autonomously transport items through the multifunctional space 400 as contemplated herein.

According to one implementation, the system (such as system 300 in combination with a system like system 40) can use information regarding the number of items of a particular type sold in the multifunctional area 400 to determine whether to transport additional items of that type to an appropriate delivery location 406 in the retail area 404. For example, the system 300/40 can be programmed with a displayed item threshold. The displayed item threshold can be a desired minimum amount of a particular item to be displayed or otherwise available for purchase in the retail space 404. This quantity can be manually programmed into the system. Thus, the system 300/40 can track the number of items of a particular type that are present in the retail area 404 by tracking both the total number of the items of that type present in the retail area 404 (by tracking the number of the items of that type already present in the retail area 404 and the number of items of that type transported to the retail area 404 from the storage area 402) and the number of that item sold at any point-of-sale location as described above. In other words, the method 500 includes comparing the collected inventory data with the programmed inventory threshold (block 520). When the number of items in the retail area 404 drops below the predetermined threshold number (by using the number of that item sold to calculate the number of items remaining in the retail area 404), the system 300/40 can trigger action to transport more items of that type from the storage area 402 to the designated delivery location 406 in the retail area 404.

When the quantity of items of a particular type present in the retail area 404 is less than the threshold, one or more of a number of different actions can be automatically triggered by the system 300/40. For example, in one embodiment, the system 300/40 can generate an alert indicating that the number of items of a particular type in the retail area 404 has dropped below the predetermine threshold number, thereby alerting a user that additional items of that type may be required to be moved from the storage area 402 to the retail area 404. The alert can be an electronic message transmitted to a phone, a tablet computer, a desktop computer, a kiosk in the retail area 404 or the storage area 402, the interface (not shown) on an autonomous transport vehicle (such as vehicle 302), or any other type of device or interface. This notification can include a quantity of items of that type that should be moved from the storage area 402 to the designated delivery location 406 in the retail area 404.

The method can include collecting items of the required type from the storage area 402 to be transported to the retail area 404. In other words, the method includes collecting inventory to be moved from the storage area 402 to the retail area 404 (block 525). The movement of the items can be completed in a variety of ways. In some embodiments of the method, at the same time as the alert discussed above, an electronic instruction can be transmitted to an autonomous transport vehicle (such as vehicle 302) or vehicle and cart (such as vehicle 302 and cart 304) to instruct the vehicle to travel to a predetermined location within the storage area 402 so that a user can place the required number of items of the requested type onto the vehicle or cart for transport to the designed delivery location 406 in the retail area 404. Alternatively, the autonomous transport vehicle (such as vehicle 302) or vehicle and cart (such as vehicle 302 and cart 304) can remain in position at a predetermined return location 410 or other location within the storage area 402 and the items of the required type are transported by a user to the location and loaded onto the vehicle (such as vehicle 302) or cart (such as cart 304).

Once the items of the required type are collected in the storage area 402 (block 525), the method can also include distributing the items to the appropriate delivery location 406 in the retail area 404 (block 530). As discussed above with respect to FIG. 14, the autonomous vehicle (such as vehicle 302) can be programmed to travel to a predetermined location in the retail area 404, such as a delivery location 406. In some embodiments, the predetermined location can be associated with a specific type of item or a specific area within the retail area 404. As discussed above, various predetermined delivery locations 406 can be programmed within the system (such as system 300/40). As discussed above, depending on the type of item to be transport, the delivery vehicle (such as vehicle 302) can travel to the predetermined delivery location 406 closest to the shelves or other display structures that hold that particular type of item. This strategic positioning of delivery locations 406 in optimal locations within the retail area 404 reduces the need for employees to travel throughout the store (or other multifunctional location 400), thereby reducing the total time needed to stock various items in the retail area 404 (or, in a similar fashion, in the storage area 402). This also reduces the need for employees to carry or move items throughout the store, which can reduce the risk of injury to the employees and/or damage to the items.

According to various implementations, the various autonomous delivery vehicles (such as vehicle 302 or any other vehicle embodiment herein) or vehicles and carts (such as vehicle 302 and cart 304 or any other cart embodiment herein) can transport and distribute multiple items at a time. For example, the system (such as system 300/40) can generate a notification indicating that two or more types of items (such as a first product and a second product) have dropped below the minimum threshold number of such items in the retail area 404. The system 300/40 can collect a quantity of both the first and second product in a manner described above and distribute the inventory as also described above. In some embodiments, the first and second products (or other items) may be transported the same predetermined delivery location 406, depending on the types of products. In other embodiments, the first and second products may be distributed at different predetermined delivery locations 406.

In certain alternatives, the method can also include tracking the location of the autonomous transport vehicle (such as vehicle 302) and/or cart (such as cart 304) (block 535). The system (such as system 300/40) can use the tracked location to optimize the path along which the system 300 travels to deliver an item.

In addition, the method can include returning the autonomous vehicle (or vehicle and cart) to the storage area 402 (block 540). In some examples of the method, the system (such as system 300) can return to a predetermined return location 410 in the storage area 402, where the system 300 can be on standby until items need to be moved into the retail space 404 again. In other examples of the method, the system (such as system 300) can return to the storage area 402 and begin the process of moving items into the retail space 404 immediately.

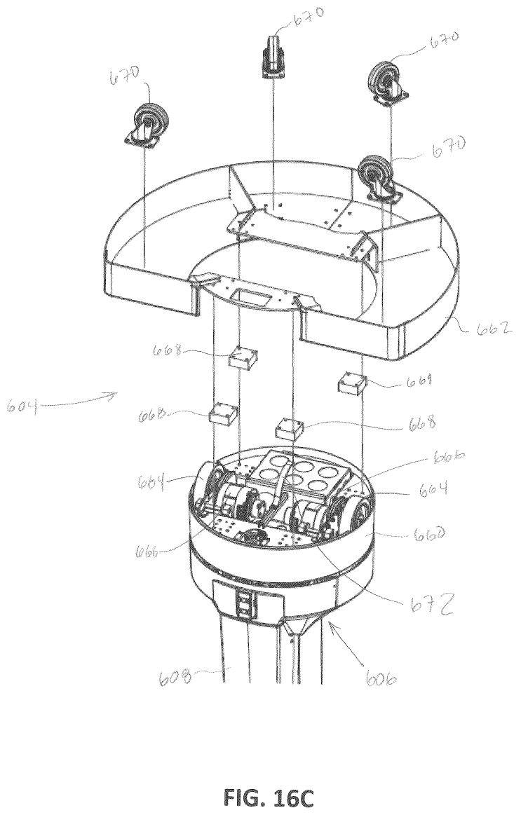

In certain alternative embodiments as shown in FIGS. 16A-16C, a mobile tracking system that detects, tracks, and updates an inventory database automatically for various items (such as pallets of goods) that are stacked on a floor or on shelves of a warehouse or the like may be desired. In such embodiments, it can be important to be able to track the number of remaining items from one or more pallets, shelves or the like from which one or more items has been removed. In other implementations, it may be helpful to gather information about pallets behind the front row of pallets (or in the rear of a stack of pallets) directly with imaging devices such as cameras or other sensors. In some embodiments such as shown in FIG. 16A-16C, a system 600 may include a self-propelled and autonomous prime mover or vehicle 602 (similar to any of the vehicles or prime movers disclosed or contemplated elsewhere herein) that may have a mast 610 that can reach over the top edge of the front pallet or row or pallets or lower shelves of pallets such that pallets located behind the front pallet or row of pallets are within the line of sight of the camera, the sensor, or both. In this way, a warehouse storing pallets of goods that are not shelved (or shelved on lower shelves) may be visually observed (i.e., scanned, analyzed, imaged, digitized, detected, inspected, and/or otherwise examined) by the vehicle 602 and/or verified and recorded by the system 600 such that real-time tracking of the inventory within the warehouse is achieved. Alternatively, or in addition, versions of the vehicle 602 with the extended mast 610 can be used to capture information about items (including items on pallets) on several levels of shelves, as will also be discussed below.

In some embodiments, the system 600 includes the networked based system such as shown above in FIG. 2 as the system 40 (or any other network as disclosed or contemplated herein). It should be known that in some embodiments, one or more of the database 48 (and/or one database among a system of databases 48), the server system 46 (and/or one server among a system of servers 46), and/or client computers 50 (and/or one client computer among a system of client computers) may be housed on the vehicle itself, within the building or space and connected by Wi-Fi or another wireless communication protocol, or connected through the Internet connected network offsite at a centrally located headquarters or similar offsite location.

In such embodiments, the vehicle 602 may be substantially similar to the vehicle 302 of the system 300 as shown in FIG. 10A, other than the differences specified below. In some embodiments, the vehicle 602 includes a base 606 with a positioner portion 604, a navigation tower 608, and a scan tower or detection mast (or collection mast) 610. In such embodiments, the positioner 604 includes positioning means such as wheels and associated motors to drive the wheels such that the vehicle 602 is positioned in the desired position and in the desired orientation. The positioner 604 can be a portion of the base 606 and, in the specific example as shown, can be the bottom portion or section of the base 606. The scan tower or detection mast 610 may extend upwardly from the center of the base 606. The navigation housing or tower 608 can be attached at its lower portion to the base 606 and further can be attached to the side of the mast 610 as shown. More specifically, the navigation housing 608 can be attached to the side of the main portion 620 of the mast 610.

In some embodiments, the base 606 may be any size, shape, and configuration and provide a stable platform for the navigation tower 608 and the sensor mast 610, and provide electrical power and signals to the respective elements in the positioner 604 (e.g., the wheel motors and/or any other on-board elements of the positioner 604), the navigation housing 608 (e.g., the camera, sensor, and/or any other on-board elements of the navigation housing 608), and the sensor mast 610 (e.g., RFID reader(s), camera(s), lidar(s), other sensors, and/or any other on-board elements of the sensor mast 610).

As shown in FIGS. 16A and 16B, the base 606 can include the positioner 604 and a housing disposed above the positioner 604 with a smaller width compared to the positioner 604 and a frustoconical shape with a cylindrical lower portion coupled to the positioner 604. The base 606 may include a charging port 614 accessible on a front portion of the base 606 such that the charging port 614 may plug into a charger on a wall or other area (or as part of a docking/charging station, as will be discussed in further detail below) when an on-board battery (not shown) of the vehicle 602 needs recharging. In some embodiments, as also discussed in more detail below, the battery may be a swappable battery such that when a battery is depleted, the battery is quickly swapped out minimizing the downtime for the vehicle 602 or fleet of vehicles 602. In such a way, as a non-limiting example, a vehicle that may cover 200,000 square feet on an 8-hour charge, recharge for 8 hours, and cover another 200,000 square feet in another 8-hour charge totaling 400,000 in a 24-hour span, may cover 600,000 in a 24-hour span with two quick-swaps of batteries.

In some embodiments, one or more of the database 48 (and/or one database among a system of databases 48), and/or the server system 46 (and/or one server among a system of servers 46) may be housed on the vehicle 602 within the base 606. In some embodiments, just below the charging port 614 may be a 2-dimensional lidar sensor 680 to aid in navigating the vehicle 602 around the warehouse. Alternatively, any type of sensor 680 can be disposed below the charging port 614 or elsewhere on the base 606 to aid with navigation and avoidance of obstacles.

In some embodiments, the positioner 604 of the base 606 may be integrally formed with the upper housing of the base 606 and form the bottom portion of the base 606 and may be any size, shape, and configuration to provide a stable base for the vehicle 602 and to provide the means to move and position the vehicle 602 in a desired location and in a desired orientation. The positioner 604 portion of the base 606 is generally a cylindrical segment in shape. In some versions, as best shown in FIG. 16C, the positioner 604 can have a planar or flat portion in the periphery of the cylindrical shape such that the flat portion makes it possible for at least a portion of the navigation tower 608 (such as the charging port 614, for example) to contact or get close to a wall, docking/charging station, or the like. The positioner 604 of the base 606 may include areas whereby ballast (not explicitly shown) may be added to provide added stability in embodiments where the mast is extended or has a sufficient length and/or weight such that additional ballast can help to minimize the risk of or prevent the vehicle 602 from tipping over.

As depicted FIG. 16C, the positioner 604 of the base 606 may include one or more drive wheels 664 operably coupled to motors 666 within an inner housing 660 of the positioner 604, the drive wheels 664 extending at least partly from a bottom side of the positioner 604 to propel and orient the vehicle 602 to the desired location and orientation. In the version as shown, each drive wheel 664 has a separate motor 666 attached to, such that each wheel 664 is actuated and controlled separately. Alternatively, a single motor can be coupled to both drive wheels 664. In some embodiments, one or more caster wheels 670 may be rotatably attached to a bottom side of the positioner 604, (and in some cases can be attached to the bottom side of an outer housing 662 as in the example shown in FIG. 16C), to add support for the vehicle 602. Alternatively, any known passive (non-drive) wheels can be attached to the underside of the base 606. In some embodiments, the outer housing 662 may be coupled directly to the inner housing 660 or attached through attachment blocks 668. In some embodiments, an anti-static strap 672 may extend downwardly and electrically connect the base 606 with ground to alleviate and/or dissipate static buildup within the vehicle 602. Alternatively, any known anti-static structure can be used.

The positioner may be electrically and mechanically integrated into (or coupled to) the base 606 such that the base 606 is stably secured and instructions received and/or processed by the base 606 are converted to motor signals which then effect motion of the wheels 664. In the embodiment shown in FIG. 16A-16B, the wider footprint (i.e., wider diameter) of the positioner 604 portion of the base 606 allows for more stability of the vehicle 602 with potentially taller and heavier masts 610.

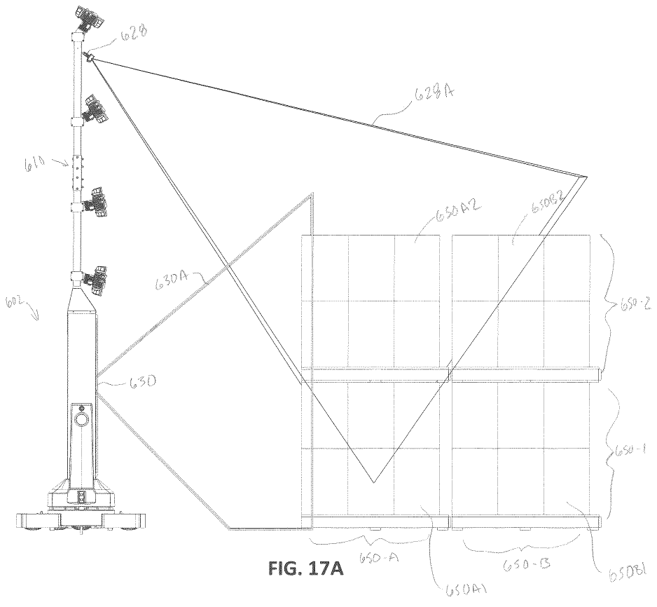

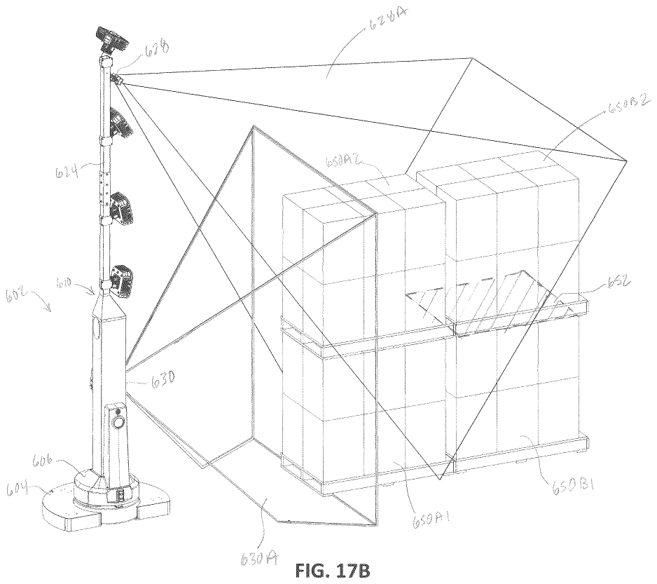

In some embodiments, the navigation tower 608 may be any size, shape, and configuration and provide detection abilities (e.g., via one or more cameras, lidar, and/or other sensors) such that precise positioning and orientation of the vehicle 602 may be accomplished. As shown in FIGS. 16A-17B, the navigation tower 608 may be generally rectangular prism in shape with a height much greater than a width and depth. As best shown in FIGS. 16A-B, the navigation tower 608 may include both a first sensor 616 (e.g., an RFID sensor, a lidar sensor, and/or any other type of location sensor)and a second camera 618, and/or any other sensors and/or lighting to guide the vehicle 602 and allow the vehicle 602 and/or the system 600 to have accurate positioning and orientation data on the vehicle 602. In one particular example, the sensor 616 is a three-dimensional lidar sensor 616, and the sensor 618 is a camera 618 (such as a stereo camera, for example). In some embodiments, one or more of the client computers 50 (and/or one client computer among a system of client computers) may be housed on the vehicle 602 and accessible from the navigation tower 608.

In some embodiments, the sensor mast 610 may be any size, shape, and configuration to provide attachment points and electrical connections for various sensors and cameras placed a desired locations, heights, and orientations along the sensor mast 610. As shown in FIGS. 16A-16B, the sensor mast 610 has a main portion 620 and an upper portion 622 extending upwardly from the main portion 620 to a desired height such that items and/or pallets of many sizes and depths and/or on shelves of varying heights may be tracked as described in more detail below. In some embodiments, the lower or main portion 620 of the sensor mast 610 may be generally a square shape extending upwardly from the base 606 and have one or more sensors 630 (e.g., cameras, barcode readers, RFID readers, and/or any other sensors) disposed on a side wall of the main portion 620 of the sensor mast 610. In the embodiment shown in FIGS. 16A-16B, the sensors 630 may be stereo imaging devices 630 such that a depth of field may be observed and analyzed by the system 600.

In some embodiments, the upper portion 622 of the sensor mast 610 may include a post or pole 624 extending upwardly from the main portion 620 such that the main portion 620 has a larger diameter (or width and depth) in comparison to the upper portion 622. As shown in FIG. 16A, the pole 624 may comprise a lower pole 624A and an upper pole 624B attached by a connector 634 to extend the pole 624 upwardly to the desired height. That is, according to certain implementations, the upper pole 624B can be vertically extendable and retractable in relation to the lower pole 624A at the connector 634. Thus, in some embodiments, the pole 624 may be extendable, or a single non-extendable pole 624.

At or near the top of the pole 624 may be one or more sensors 628 (image sensors include depth perception such as stereo cameras, lidar, a combination of image and lidar, and/or any other sensor configured to sense depth as well as image) or any other sensor that is located at a height that can be higher than the height of the stack of pallets to be observed and is angled slightly downwardly such that the camera 628 has a field of view that reaches behind a front row of pallets as is described in more detail below.

In some embodiments, a number of adjustable, removable sensors 626 (e.g., image sensors or cameras designed to capture and analyze images such as barcodes) may be attached to the pole 624 at various heights via adjustable attachments 632 (e.g., any attachment means known in the art such as adjustable brackets or the like). As shown in FIG. 16A according to one example, four cameras 626 may be placed at various adjustable heights along the upper portion 622 of the mast 610. Although it should be known that 2, 3, 5, 6, 8 or any other number of cameras 626 may be used. The cameras 626 are also angularly adjustable as well such that each camera 626 can be separately angled or “aimed” to maximize the vertical view of the cameras 626 to accommodate a stack of pallets 12-16 feet high (i.e., assuming a pallet height of 4 feet, a stack 3-4 pallets high, although it should be known that other heights may be accommodated) or higher or to accommodate items or pallets placed on a number of shelves of varying heights. Alternatively, the cameras 626 can be “aimed” to be directed at other items at various heights. The sensors 626 can be any imaging device or sensor that is able to read and/or process a barcode that is within the field of view of the cameras 626 and communicate, either directly or indirectly, the information relating to the barcode to the system 600. In addition, although not shown, another sensor (similar to sensor 628) may be included on the sensor mast 610 on an opposite side of the sensor mast 610 from the array of sensors 626 and pointing upwardly at 30 to 45 degrees and configured to image the upper steel within the warehouse for further navigation or other purposes. In a further alternative, any combination of cameras (such as cameras 626) and other sensors of any kind (including the sensor 628) can be adjustably attached to the mast 610 to collect any relevant information related to various items and/or pallets in a target area (such as a warehouse or any other type of space or area), including items and/or pallets in stacks and/or on shelves.

Looking at FIG. 17A, in some embodiments, the vehicle 602 may be used to determine the presence or absence of pallets 650 of items behind an easily tracked front row 650-A of pallets. Alternatively, the vehicle 602 can be used to track (including determining the presence or absence) of items that are not on pallets and/or are on shelves in the same fashion as described herein with respect to pallets. In FIG. 17A, a front row of pallets 650-A may be tracked by the sensors 630, but the field of view 630A of the sensor 630 may not be available to view a second row 650-B. To view the second row of pallets 650-B, a sensor 628 (e.g., a camera or other imaging sensor, a lidar sensor, both a camera and a lidar sensor, and/or any other sensor) may be disposed at or near the top of the detection mast 610 such that the imaging device 628 has a field of view over the upper row 650-2 of pallets to a top of the rear row 650-B of pallets 650.

In such embodiments, the pallets may be about 4 feet tall, and the stacks of pallets 650-1, 650-2 sitting on a floor of the warehouse may rise to two pallets high, or about 8 feet high. In some embodiments, to get the height necessary for the sensor 628 to gain line of sight to the pallets in a row behind the front row is about 4 feet over the front row, or about 12 feet high. In this way, the sensor 628 is able to observe the presence of a pallet 650B1 (such as top portion 652 of the lower rear pallet 650B1) or 650B2 and communicate to the system 600 an accurate pallet count even in situations where pallets are stacked one behind another.

In such embodiments, the sensors 630 may include RFID readers, barcode readers, and/or any other type of sensors such that the number of pallets and/or the stock keeping unit (SKU) of each pallet is observed and communicated to the system 600. In some embodiments, pallets in obscured rows such as shown by 650-B that are not able to be directly detected, may be assumed to be the same product or SKU as the pallet in the row 650-A directly in front of them that are able to be directly detected and are thus observed and communicated to the system 600 as such.

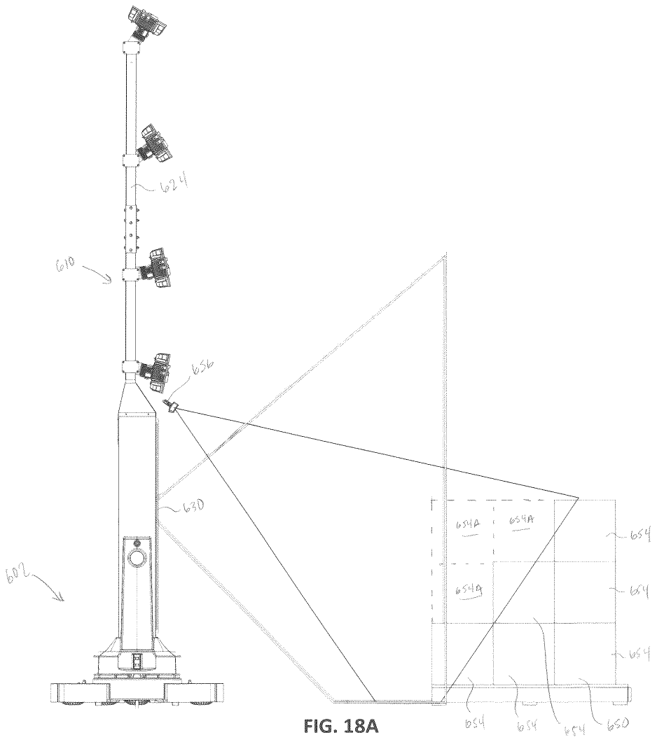

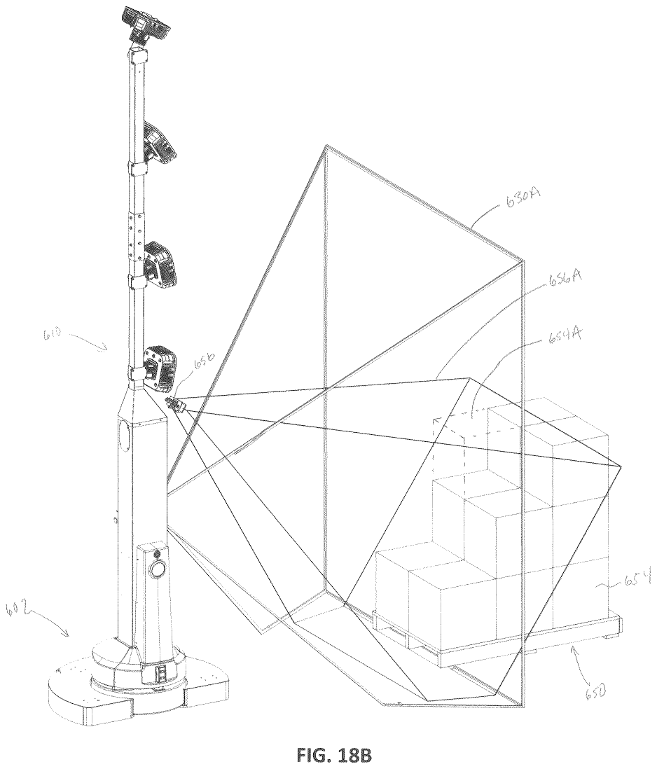

Looking at FIGS. 18A and 18B, in certain alternative embodiments, pallets of goods may include a number of smaller packages, boxes, cases, or items 654 (hereinafter collectively referred to as “cases”) of the goods or other items on the pallet 650. In such embodiments, it may be desirable to identify the number of cases 654 remaining on the pallet for a more granular inventory verification of inventory counts of the cases.

In such embodiments, the imaging device or sensor 656 may include a light detection and ranging (lidar) device. In some embodiments, the lidar device 656 may be directed to a pallet 650 that is at least partially “picked from” (e.g., at a discount warehouse club retail outlet where consumers take cases directly from the pallet). That is, the sensor 656 can be used to track the removal or absence of one or more items from the pallet, area, or shelf. In such embodiments, the lidar device 656 creates a digital twin of the contents of the warehouse or other space by creating a point cloud representing the present cases 654 on the pallet 650 after some cases 654A have been removed (it should be pointed out that for clarity only one used or removed case 654A is shown in FIG. 18B). The system may then compute the present volume of the pallet, and compare that with a predetermined full volume (i.e., the volume with all cases 654A still on the pallet 650) of a pallet of that particular SKU to determine how much of the volume of the pallet is absent (because of the items no longer being present, for reasons such as having been removed by consumers in retail settings).

The system 600 may then compute what the missing volume translates to in terms of cases 654A that have been removed (and/or purchased in a retail setting) and how many cases 654 remain on the pallet 650 and annotating the pallets and cases with their associated SKU, and updating the Warehouse Management System (WMS) 600. In such embodiments, a detailed inventory of that SKU may be computed at a more granular case level and reported by the system 600. This process may be a continuous process such that the point cloud and associated annotations are constantly evolving and creating up to the hour updates on inventory within the warehouse. In some embodiments, a color or other distinguishing feature (e.g., size, shape, material, and/or a combination or other characteristic) of any given pallet may also be observed such that an inventory of the pallets themselves (i.e., the manufacturer or owner of the empty pallet itself) may be tracked in real-time or nearly real-time. Alternatively, the system 600 can be used to similarly track the presence and/or absence of various items in other configurations, including those not on pallets and/or those on shelves.

In some embodiments, the lidar device (or other sensor) 656 is combined in the system 600 with a camera imaging device 628 to determine the total number of cases 654 in a predetermined space (such as a warehouse or retail floor or area). For instance, in such embodiments, the mobile tracking system 600 may direct the vehicle 602 to approach a stack of pallets 650 that is 3 pallets across, 4 pallets deep, and stacked on shelves reaching up to 4 pallets high (although it should be known that the numbers in the stack of pallets may differ from this non-limiting example without deviating from the scope of the disclosure). Alternatively, the system 600 may direct the vehicle 602 to approach a stack of items or a set of shelves containing items that may or may not be on pallets. The camera 628, using one or more of the strategies and/or elements from one or more of the embodiments above, may take a total inventory of the pallets 650 or items of a given SKU on the floor, and compute a total number of cases 654 that would be available if each were in the full state. In some embodiments, the top pallet 650 on the top shelf may reach as high as about 35 feet and the camera 628 is able to reach as high as about 38 feet to read a barcode on each of the pallets 650 to identify the particular SKU in each stack.

In some embodiments, the lidar device 656 may then scan each of the pallets 650 on the bottom row 650-1 to create a point cloud representing the current status of present cases 654 each of those pallets. The point cloud is analyzed such that a remaining volume of each of the front pallets 650-A in the bottom row 650-1 is computed and compared to a predetermined full volume of the pallet 650 for that particular SKU, and then compared with the volume of a single case 654 to compute a specific number of cases 654 remaining on each of the front pallets in the bottom row 650A1. In some embodiments, the pallets behind and above these pallets may be assumed to be full (as typically users pull from the front pallets in the bottom row), and the number of these pallets (in this non-limiting example it would be [3×4×4]−3=45 pallets) is then multiplied by the known number of cases 654 in a full pallet 650 for that SKU. This number may then be added to the number of cases 654 computed by the system to be present in the front row of bottom pallets 650A1 to arrive at a total inventory for that SKU at the case level.

In some embodiments, the system 600 stores the information as it is received by the vehicle 602 in real-time or nearly real-time in structured database or databases. In still other embodiments, the information may be gathered in a large language model (LLM) stored in memory of the system 600 such that unstructured queries may be made of the system 600 and real-time answers to the queries result. In some embodiments, the system 600 may include an LLM that provides recommendations to most efficiently deploy the pallets to minimize total travel of forklifts, to minimize hotspots for forklifts within the warehouse, to maximize sales of certain SKUs within the warehouse, or any combination of these and other characteristics of the layout of the warehouse. In still other embodiments, the LLM may include maintenance schedules for the vehicles 602 themselves to minimize downtime of the vehicles such that maximum efficiency of the entire system 600 is achieved.

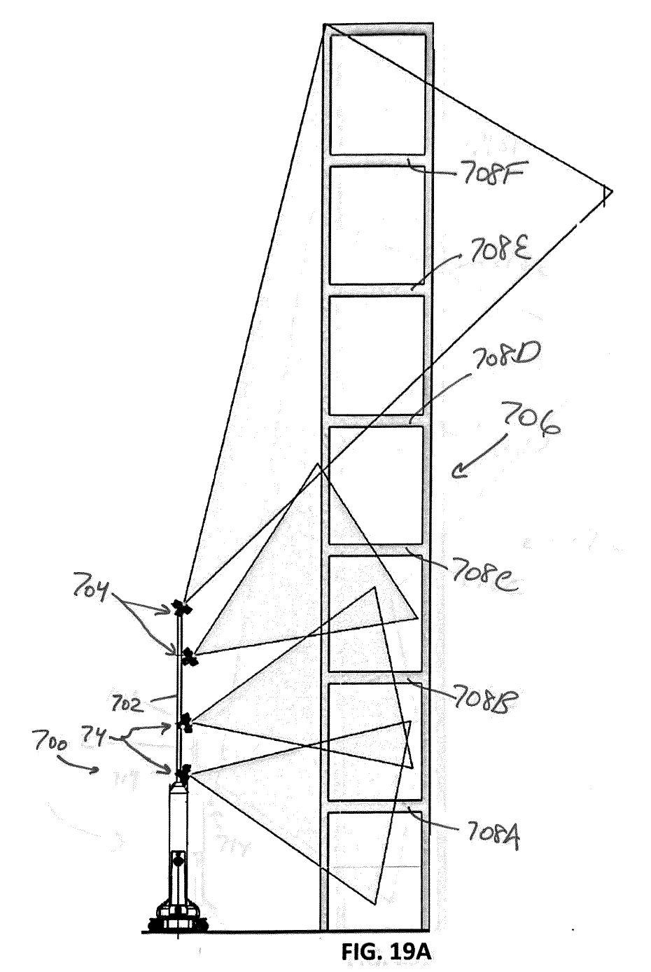

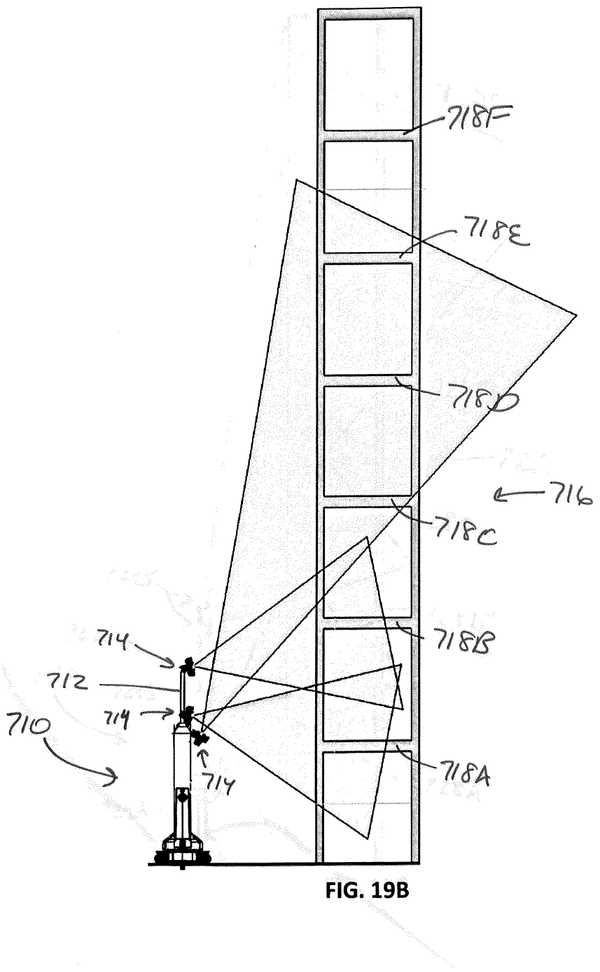

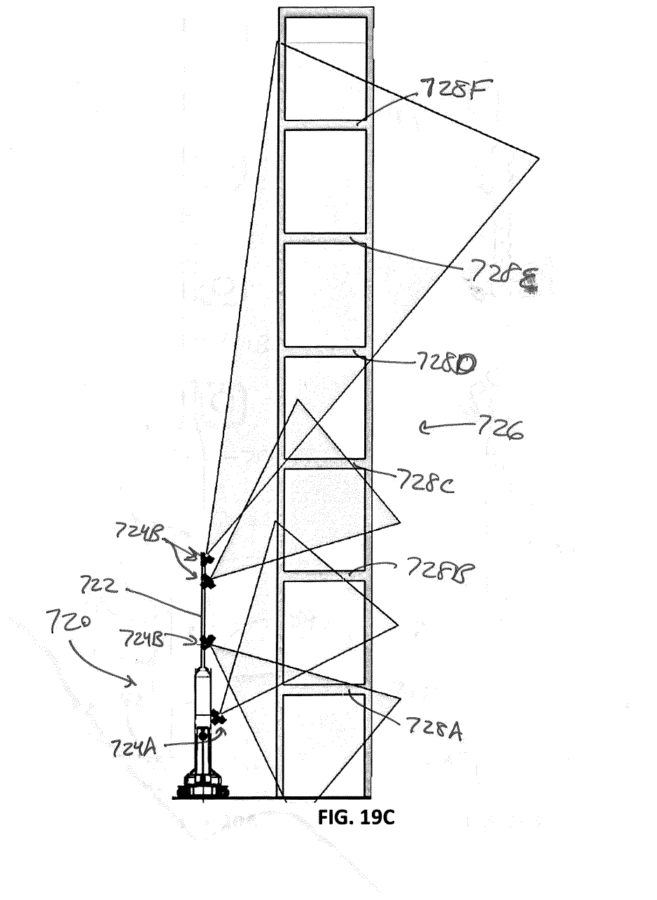

In various alternative embodiments as shown in FIGS. 19A, 19B, and 19C, any of the autonomous vehicles disclosed or contemplated herein (including, for example, the vehicle 602 discussed above and/or the vehicle 740 discussed below) can be used to collect information and/or track items on sets of shelves. It should be noted that the autonomous vehicle embodiments described below can have the same or substantially similar components, features, and functionality as the vehicle 602 described above except as expressly described herein. For example, in FIG. 19A, an autonomous vehicle 700 is shown with four sensors 704 attached to the mast 702 and aimed such that any items on any of the shelves 708A-708F of the shelving unit 706 fall within the field of view of one of the four sensors 704 (along with any items on the floor underneath the bottom shelf 708A). Similarly, in FIG. 19B, an autonomous vehicle 710 is provided with a shorter mast 712 (in comparison to the mast 702 above) having three sensors 714 attached thereto and aimed such that any items on any of shelves 718A-718E of the shelving unit 716 fall within the field of view of the three sensors 714 (along with any items on the floor underneath the bottom shelf 718A). In addition, in FIG. 19C, an autonomous vehicle 720 is shown with a mast 722 that is shorter than the mast 702 but taller than the mast 712 and has one sensor 724A attached to lower section of the mast 722 and three sensors 724B attached to the upper section of the mast 722. In this embodiment, the sensors 724A, 724B can be aimed such that any items on any of the shelves 728A-728F of the shelving unit 726 fall within the field of view of one of the sensors 724A, 724B (along with any items on the floor underneath the bottom shelf 728A).

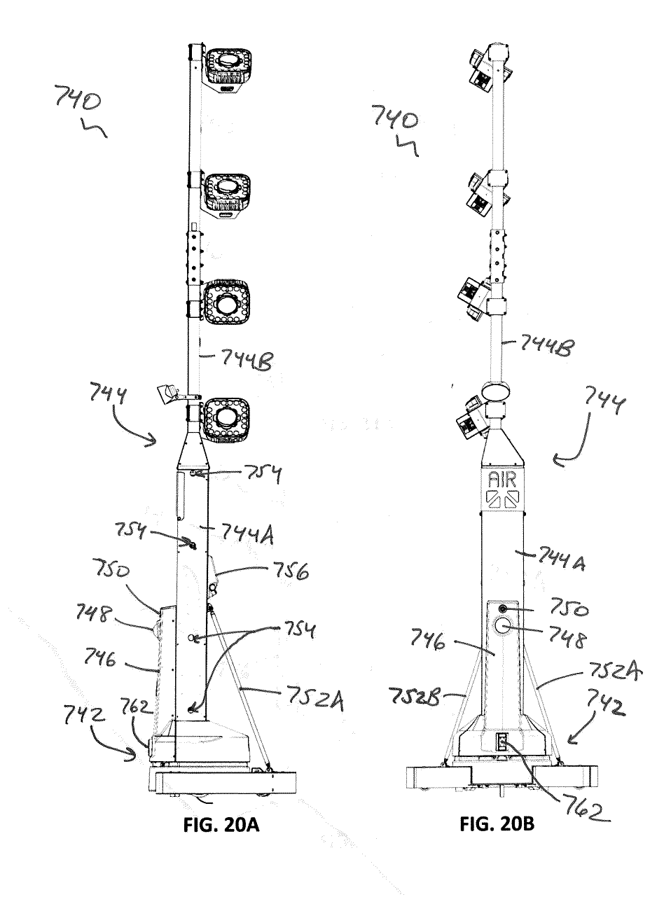

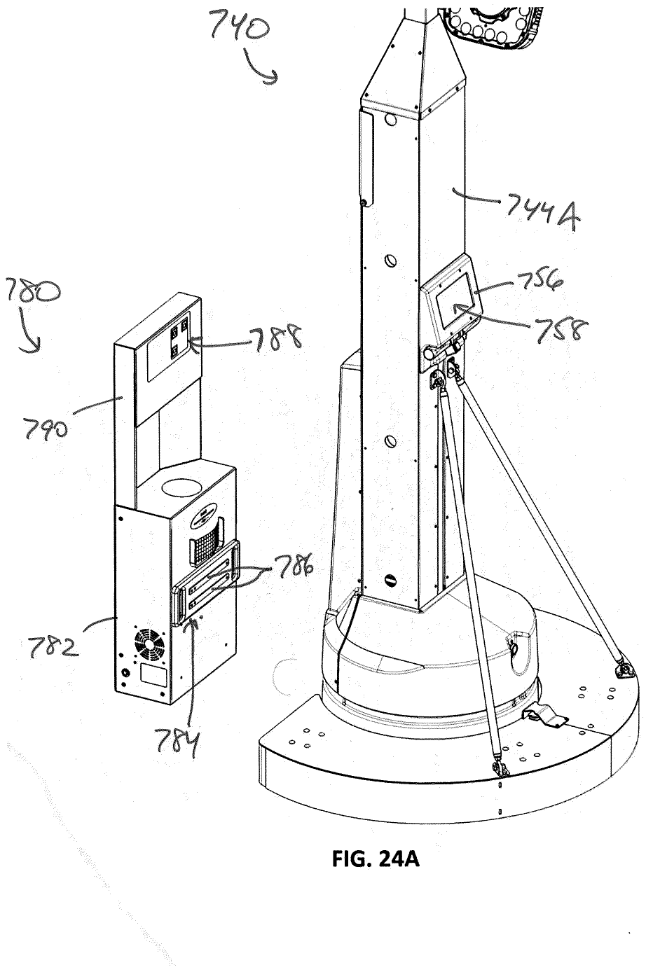

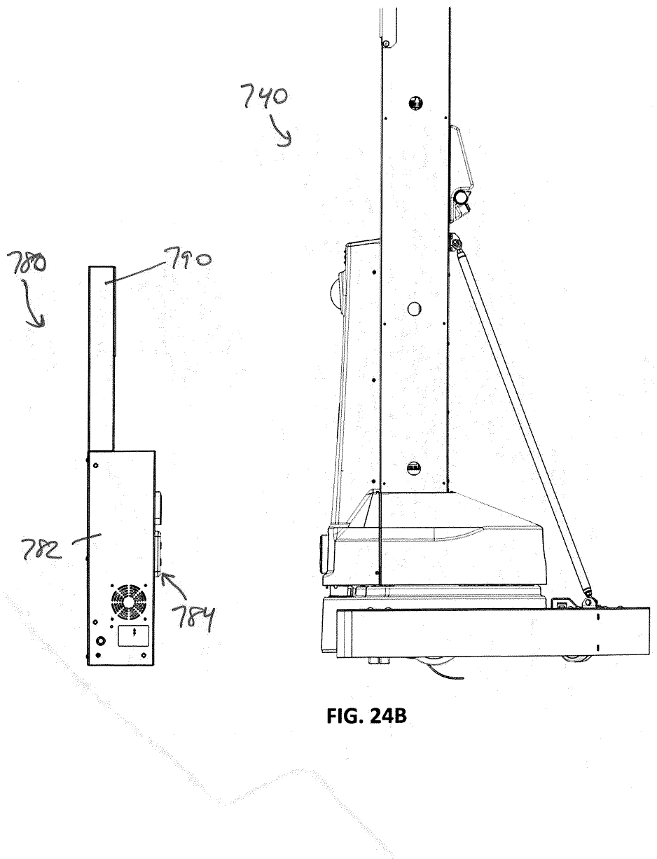

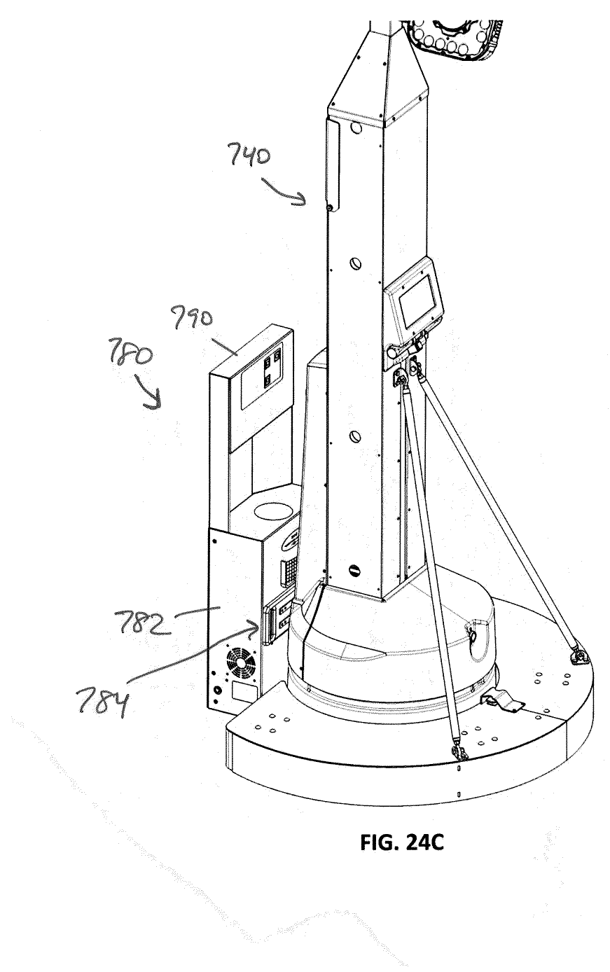

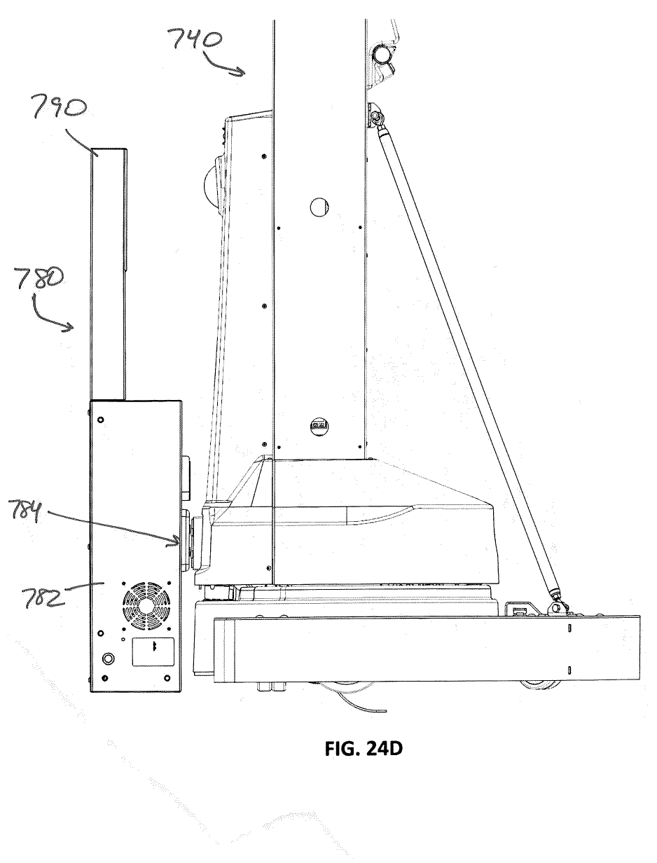

Another implementation of an autonomous vehicle 740 is shown in FIGS. 20A-23. One of skill understands that this vehicle 740 can be a component of an overall system similar to system 600 or any other system disclosed or contemplated herein for tracking and/or moving items (or providing cleaning or disinfection as described elsewhere herein) within a target area such as a warehouse or the like. It should be noted that the autonomous vehicle embodiment 740 can have the same or substantially similar components, features, and functionality as the vehicle 602 described above except as expressly described herein. In this embodiment, as best shown in FIGS. 20A and 20B, the vehicle 740 has a mast 744 that is attached to the base 742 with the additional structural support of two support struts 752A, 752B as best shown in FIGS. 20A and 20B. The struts 752A, 752B are elongate rods or tubes 752A, 752B that are coupled at one end to the first mast section 744A and at the other end to the base 742 such that the struts 752A, 752B. In addition, the first mast section 744A in this exemplary embodiment has additional openings 754 defined in the first mast section 744A that can be configured to receive additional sensors (not shown) for use in the navigation of the vehicle 740 and/or the collection of information about the items in the target area. In further alternative embodiments, the second mast section 744B can also have similar openings (not shown) to receive additional sensors (not shown) as well. In addition, the first mast section 744A can have a user interface 756, as best shown in FIG. 24A. In the specific example depicted in FIG. 24A, the user interface 756 includes a touchscreen 758. Alternatively, the user interface 756 can be any known form of interface with any known input and output features for use in controlling the vehicle 740 and/or the overall system to which the vehicle 740 is coupled (similar to system 600 above or any other system as disclosed or contemplated herein).

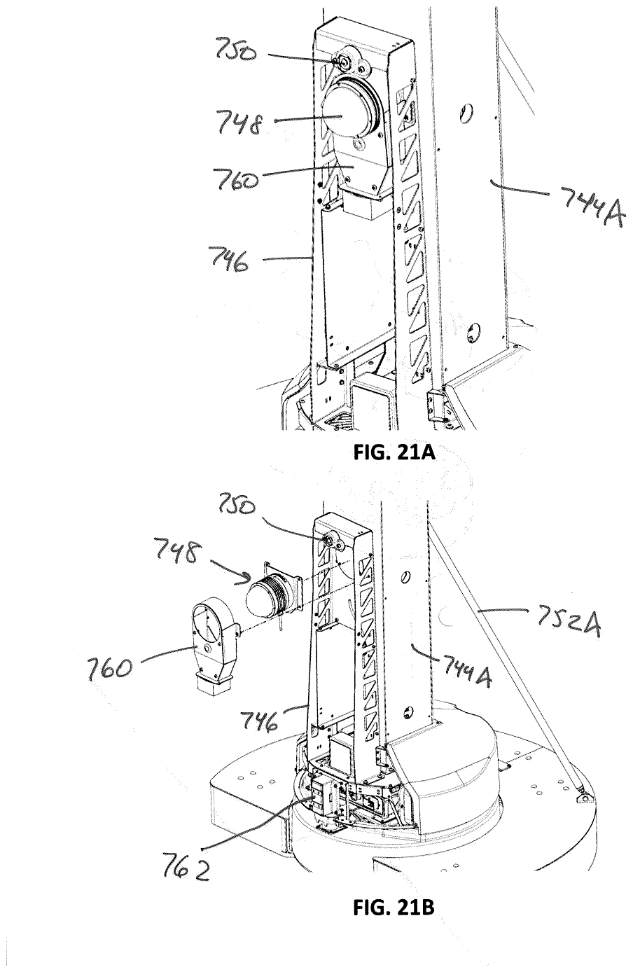

As best shown in FIGS. 21A and 21B, the vehicle 740 can have a navigation housing 746 similar to that housing 608 described above), with a 3D lidar 748 and a camera 750 incorporated therein. Alternatively, the sensors 748 and 750 can be any known sensors 748, 750 that can be used for navigation and obstacle avoidance of the vehicle 740. According to certain versions, the sensor 748 can be retained within the navigation housing 746 with a sensor housing 760 as shown. In addition, as shown in FIG. 21B (along with FIGS. 20A and 20B), the vehicle 740 can also have a charging plate 762 disposed in or otherwise associated with the base 742 that can be coupled to an external power source (not shown) to charge the vehicle 740. Additional detail about a particular version of a charging plate (such as plate 762) will be discussed in additional detail below in the context of a charging or docking station.

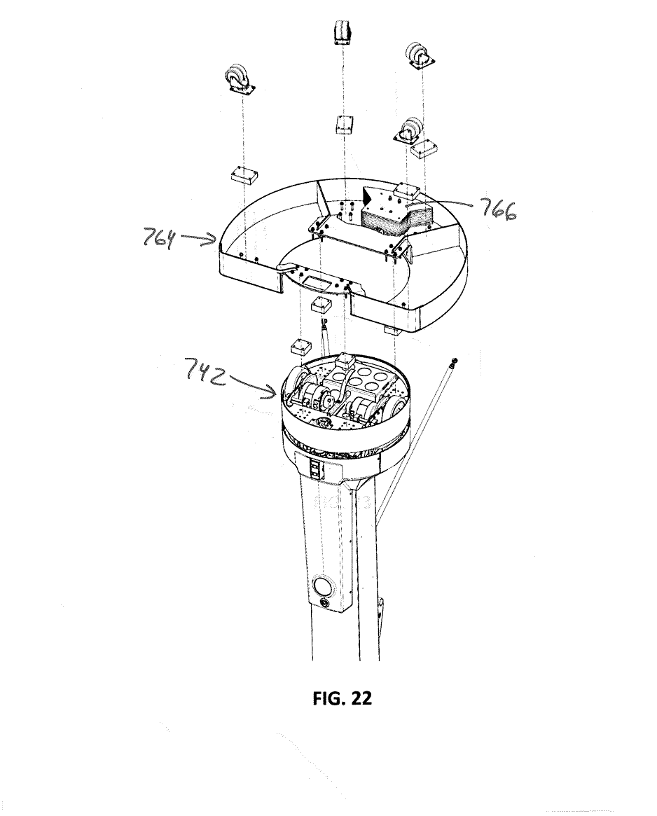

As best shown in FIG. 22, the underside of the base 742 can have components similar to the base 604 as described above. In addition, this version of the base 742 can also have an outer housing 764 disposed on the underside of the base 742 that can include an additional weight or ballast 766 that can provide additional counterweight to help prevent the vehicle 740 from tipping over as a result of the mast 744. Alternatively, the ballast 766 can be optionally incorporated into another portion of the base 604.

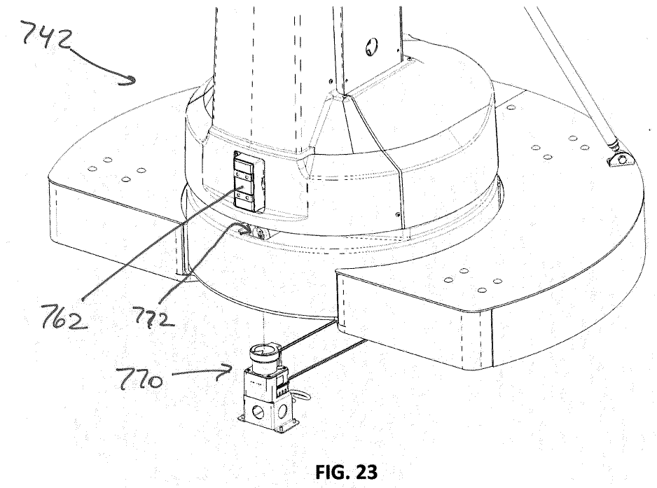

FIG. 23 depicts the 2D lidar sensor 770 that is attached to the base 742 (under the charging plate 762). That is, while the sensor 770 is depicted separately from the base 742 in the figure, when the vehicle 740 is fully constructed, the sensor 770 is disposed through the opening 772 shown in the figure such that the sensor 770 is disposed underneath the charging plate 762. One of skill in the art understands that the 2D lidar sensor 770 can be any commercially available 2D lidar sensor. Alternatively, the sensor 770 can be any known sensor 770 for use in navigation of the vehicle 740.

As best shown in FIG. 23, the charging plate 762 can have two contacts 768 on the plate 762 that are configured to electrically couple to corresponding contact strips 786 on the charging plate 784 of the docking/charging station 780 discussed below (and depicted in FIG. 24A). That is, the plate 762 and the contacts 768 are disposed at an appropriate position and height on the vehicle 740 such that they can easily be positioned in contact with the charging plate 784 of the docking/charging station 780 as discussed in additional detail below.

In further alternative implementations, any of the various autonomous vehicles disclosed or contemplated herein can have a docking and charging feature. For example, FIGS. 24A-24D depict one version of the autonomous vehicle 740 with a docking/charging station 780 to which the vehicle 740 can be coupled as needed for charging the battery/batteries within the vehicle 740. More specifically, FIGS. 24A and 24B depict different views of the vehicle 740 positioned near the docking/charging station 780. The station 780 has a housing 782 with a charging plate 784 having two contact strips 786 for coupling with the contacts 768 on the charging plate 762 of the vehicle 740. In addition, the station 780 has a visual code 788 (such as, for example, a QR code 788) displayed on the front of the station 780 that can be captured by one or more of the cameras or sensors on the vehicle 740 that helps the autonomous vehicle 740 to identify the station 780 and the location thereof such that the visual code 780 can help the vehicle 740 or overall system to direct the vehicle 740 into coupling contact with the station 780. In one embodiment, the code 788 is disposed on the front of an upper section 790 of the station 780. Alternatively, the code 788 can be disposed anywhere on the front of the station 780 at an appropriate height to be captured by one or more of the cameras or sensors on the vehicle 740. In a further alternative, any other locating device or system can be used to assist the vehicle 740 or related system with directing the vehicle 740 to and coupling the vehicle 740 to the station 780.

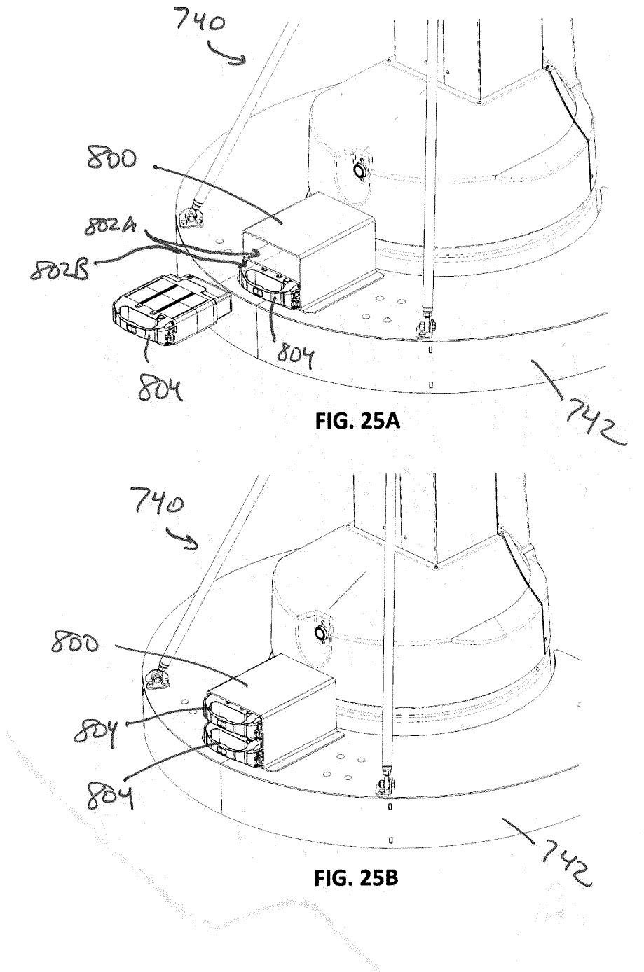

According to certain embodiments, any of the various autonomous vehicles disclosed or contemplated herein can also have a battery port for receiving one or more batteries for powering the vehicle. For example, as shown in FIGS. 25A and 25B, the autonomous vehicle 740 has a battery port 800 disposed on the base 742 that has two battery receptacles 802A, 802B, each of which can receive a separate battery 804 or battery pack. Each receptacle 802A, 802B has the appropriate electrical contacts or connections (not shown) to electrically couple with the battery 804 inserted therein. In one embodiment, the port 800 and receptacles 802A, 802B are configured to quickly receive and allow quick removal of one or two batteries 804, thereby making the exchange of batteries 804 quick and easy. In one embodiment, the batteries 804 (or packs) can be any known batteries (or packs) for use in electrical robots or vehicles. Alternatively, the port 800 can have one receptacle, three receptacles, four receptacles, or any number of receptacles. In a further embodiment, the port 800 can be any commercially available battery port for use with similar devices.

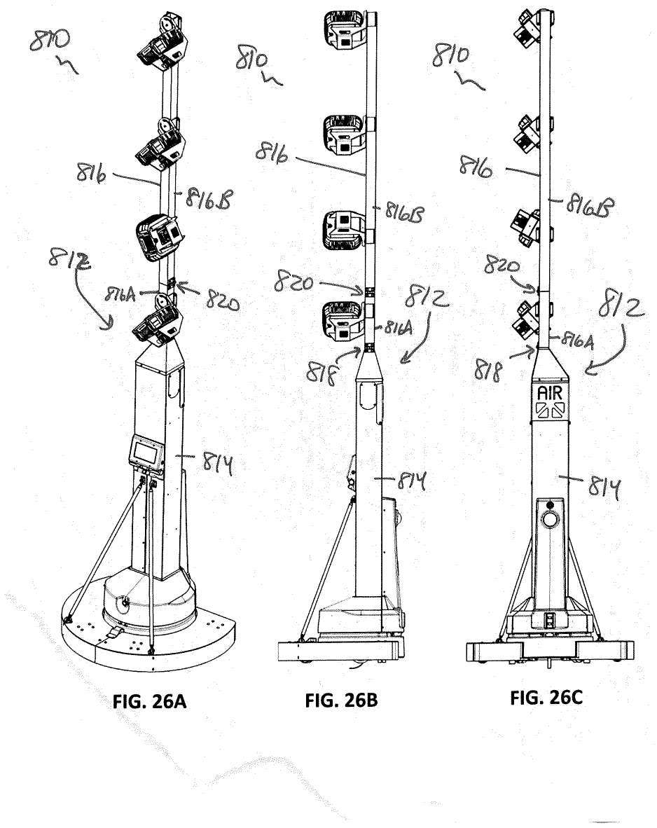

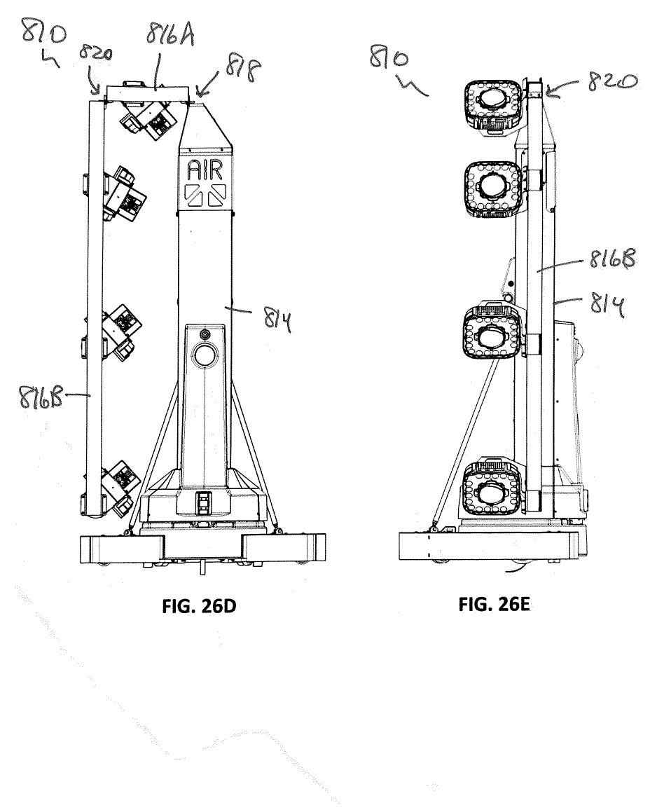

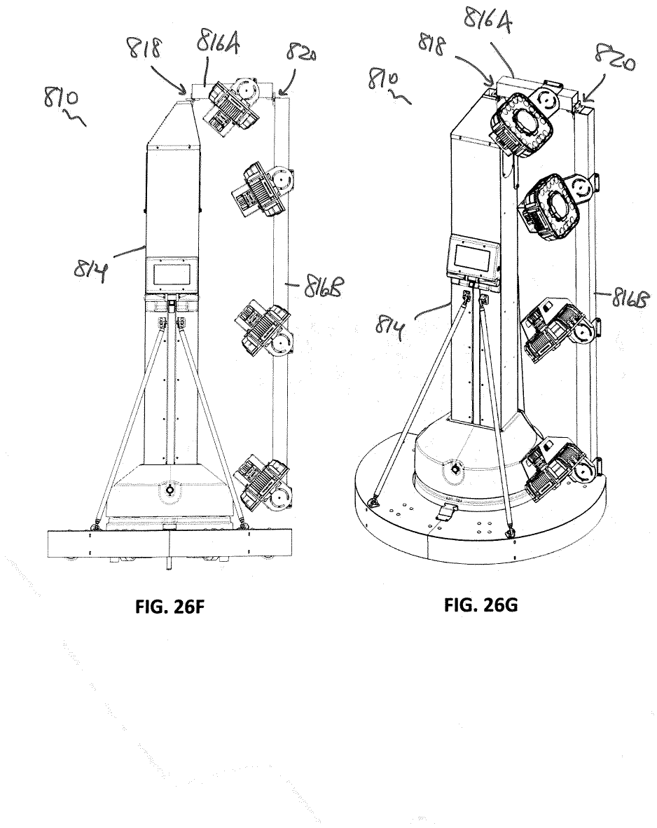

Yet another embodiment of an autonomous vehicle 810 is shown in FIGS. 26A-26G. One of skill understands that this vehicle 810 can be a component of an overall system similar to system 600 or any other system disclosed or contemplated herein for tracking and/or moving items (or providing cleaning or disinfection as described elsewhere herein) within a target area such as a warehouse, a retail space, an outdoor space, or the like. It should be noted that the autonomous vehicle embodiment 810 can have the same or substantially similar components, features, and functionality as the vehicle 602 or vehicle 740 as described above except as expressly described herein. In this embodiment, as best shown in FIGS. 26B, 26D, 26F, and 26G, the vehicle 810 has a mast 812 with a first mast section 814 and a second mast section 816 attached to the first mast section 814 such that the second mast section 816 is foldable or collapsible (as best shown in FIGS. 26D-26G). More specifically, the second mast section 816 has two sections 816A, 816B as well, with the lower section 816A rotatably coupled to the first mast section 814 at a first joint 818 and the upper section 816B rotatably coupled to the lower section 816A at a second joint 820. In one embodiment, each joint 818, 820 is a hinge joint 818, 820. Alternatively, any known joint for use with such a mast can be incorporated into the mast 812.

In operation, the second mast section 816 can be autonomously or manually collapsed or folded as shown by rotating the lower section 816A in relation to the first mast section 814 until the longitudinal axis of the lower section 816A is substantially transverse in relation to the longitudinal axis of the first mast section 814 and further by rotating the upper section 816B in relation to the lower section 816A until the longitudinal axis of the upper section 816B is substantially parallel with the longitudinal axis of the first mast section 814 as shown. Alternatively, the two sections 816A, 816B can be folded into any configuration that results in a collapsed configuration similar to that shown. The mast 812 can be moved into the collapsed configuration to reduce the height of the device 810, for storage purposes or for transport of the device 810 into or through a lower overhead clearance (such as a closet or storage bay of some kind, for example). Alternatively, the collapsed configuration can be used for any number of purposes.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Although the various embodiments have been described with reference to preferred implementations, persons skilled in the art will recognize that changes may be made in form and detail without departing from the spirit and scope thereof.

What is claimed is:

1. An autonomous robot for tracking inventory of items disposed on pallets and/or shelves within a target area, the robot comprising:
a) a base;
b) a transport apparatus in the base having at least one drive wheel and a motor operably coupled to the at least one drive wheel, wherein the transport apparatus is configured to propel and orient the robot within the target area;
c) a navigation sensor set configured to provide gather navigation and obstacle avoidance data;
d) a sensor mast coupled to and extending upwardly from the base, the sensor mast comprising a main portion and a pole coupled to the main portion, the pole being vertically adjustable between a retracted position and an extended position;
e) an adjustable sensor array mounted along the sensor mast and comprising a plurality of adjustable sensors positioned at different heights and angular orientations along the sensor mast, wherein the adjustable sensors are configured to detect items on different vertical levels at multiple heights within the target area;
f) a processor operably coupled to the navigation sensor set and the adjustable sensor array, the processor being configured to receive sensor data and determine at least one of presence, identity, or location information for items or pallets; and
g) a charging interface on the base configured to couple the robot to an external power source.

2. The autonomous robot of claim 1, further comprising a top sensor disposed proximate a distal end of the pole and aimed downward to establish a field of view over a front row of pallets to detect pallets or items located behind the front row.

3. The autonomous robot of claim 2, wherein the processor is coupled to the top sensor, wherein the processor is configured to receive sensor data from the top sensor and determine at least one of presence, identity, or location information for pallets or items behind the front row.

4. The autonomous robot of claim 1, wherein the navigation sensor set is disposed within a navigation housing on the base.

5. The autonomous robot of claim 1, further comprising a base sensor set disposed proximate a lower portion of the base and configured to scan at least a lower region of the target area.

6. The autonomous robot of claim 1, wherein the charging interface comprises a charging plate with electrical contacts configured to mate with complementary contacts of an external charger.

7. The autonomous robot of claim 6, further comprising a docking and charging station including a station housing with a station charging plate having contact strips positioned to electrically couple with the electrical contacts of the charging plate when the robot docks with the station.

8. The autonomous robot of claim 7, wherein the docking and charging station includes a visual locating feature detectable by the navigation sensor set to guide docking of the robot.

9. The autonomous robot of claim 1, wherein the base comprises a battery port having at least two receptacles configured to receive removable battery packs.

10. The autonomous robot of claim 1, wherein the base includes ballast configured to increase stability of the robot when the pole is in the extended position.

11. A mobile inventory tracking system for tracking and updating inventory of items within a target area, the system comprising:
a) an autonomous robot comprising:
i) a base;
ii) a transport apparatus in the base, the transport apparatus comprising at least one drive wheel and a motor operably coupled to the at least one drive wheel to propel and orient the robot within the target area;
iii) a navigation sensor set configured to gather navigation and obstacle avoidance data;
iv) a sensor mast coupled to and extending upwardly from the base and comprising a main portion and a pole coupled to the main portion, the pole being vertically adjustable between a retracted position and an extended position,
v) an adjustable sensor array mounted along the sensor mast and comprising a plurality of adjustable sensors positioned at different heights and angular orientations along the sensor mast and configured to detect items on different vertical levels at multiple heights within the target area;
vi) a charging interface on the base configured to couple the robot to an external power source; and
vii) a robot processor operably coupled to the navigation sensor set and the adjustable sensor array and configured to receive sensor data and determine at least one of presence, identity, or location information for items;
b) a server system having a processor and memory storing an inventory database and executable instructions, the server system being communicatively coupled with the robot via a network interface,
wherein the processor of the robot is further configured to:
a) associate the determined presence, identity, or location information with robot pose and location data;
b) transmit inventory updates to the server system for storage in the inventory database; and
c) receive navigation or task instructions from the server system, and
wherein the executable instructions of the server system are configured to:
a) cause the server system to receive the inventory updates from the robot;
b) update records in the inventory database with item identity and location information; and
c) transmit route planning or coverage pattern instructions to the robot such that the robot autonomously traverses the target area to detect items at multiple heights; and
c) a docking and charging station disposed within the target area and configured to couple with the charging interface of the robot, the robot processor being configured to initiate a docking routine to the robot based on at least one operating condition including a state of charge or completion of a tracking routine.

12. The mobile inventory tracking system of claim 11, wherein at least some of the items within the target area are disposed on pallets and/or shelves.

13. The mobile inventory tracking system of claim 11, further comprising a top sensor disposed proximate a distal end of the pole and aimed downward to obtain a line of sight over a front row of pallets to detect pallets or items located behind the front row.

14. The mobile inventory tracking system of claim 13, wherein the robot processor is configured to receive sensor data from the top sensor and determine at least one of presence, identity, or location information for pallets or items behind the front row.

15. The mobile inventory tracking system of claim 11, wherein the robot processor is configured to generate a three-dimensional representation of pallet contents from sensor data, compute a present volume of the pallet contents, compare the present volume to a predetermined full volume associated with a stock keeping unit, and determine a count of remaining cases based on a difference between the present volume and the predetermined full volume.

16. The mobile inventory tracking system of claim 11, wherein the docking and charging station includes a visual locating feature detectable by the navigation sensor set to guide docking of the robot and electrical coupling between a charging plate on the robot and contact strips on the station.

17. A method of tracking and updating inventory of items within a target area, the method comprising:
operating an autonomous robot to move and orient within the target area using a transport apparatus;
acquiring navigation and obstacle avoidance data with a navigation sensor set of the robot;
receiving, at the robot, route planning or coverage pattern instructions from the server system;
autonomously traversing the target area according to the route planning or coverage pattern instructions to detect items;
detecting items at multiple heights with an adjustable sensor array mounted along a sensor mast, the adjustable sensor array comprising a plurality of adjustable sensors positioned at different heights and angular orientations;
detecting at least one of presence, identity, or location information for items based on sensor data received from the adjustable sensor array;
associating detected information with robot location data;
transmitting inventory updates from the robot to a server system via a network interface; and
updating records in an inventory database at the server system with item identity and location information.

18. The method of claim 17, further comprising initiating a docking routine to dock the robot at a docking and charging station based on at least one operating condition including a state of charge or completion of a tracking routine.

19. The method of claim 17, further comprising aiming a top sensor disposed proximate a distal end of the pole downward to obtain a line of sight over a front row of pallets and detecting pallets or items located behind the front row based on data from the top sensor.

20. The method of claim 17, further comprising generating, from sensor data, a three-dimensional representation of pallet contents, computing a present volume of the pallet contents, comparing the present volume to a predetermined full volume associated with a stock keeping unit, and determining a count of remaining cases based on a difference between the present volume and the predetermined full volume.
